(19) United States
(12) Patent Application Publication
(10) Pub. No.: US 2026/0205489 A1
(43) Pub. Date: Jul. 16, 2026

(54) EVALUATION SUPPORT SYSTEM AND EVALUATION SUPPORT METHOD

(71) Applicant: Panasonic Automotive Systems Co., Ltd., Kanagawa (JP)

(72) Inventors: Daiki OKAZAKI, Kanagawa (JP); Masato TANABE, Kanagawa (JP)

(73) Assignee: Panasonic Automotive Systems Co., Ltd., Kanagawa (JP)

(21) Appl. No.: 19/429,859

(22) Filed: Dec. 22, 2025

(30) Foreign Application Priority Data
Jan. 16, 2025 (JP) 2025-006249

(51) Int. Cl. H04L 9/40

(52) U.S. Cl. CPC H04L 63/1433; H04L 63/1425; H04L 63/1441

(57) ABSTRACT

An evaluation support system that supports evaluation of an evaluation target device includes an obtainer and an evaluation specification generator. The obtainer obtains: threat analysis information indicating an analysis result of analyzing a threat to information security in the evaluation target device; and vulnerability analysis information indicating an analysis result of analyzing a vulnerability of the information security in the evaluation target device. The evaluation specification generator generates evaluation specification information including a plurality of evaluation specifications for the evaluation target device, based on the threat analysis information and the vulnerability analysis information.

### CROSS REFERENCE TO RELATED APPLICATION

The present application is based on and claims priority of Japanese Patent Application No. 2025-006249 filed on January 16, 2025.

### FIELD

The present disclosure relates to an evaluation support system and the like that support evaluation of an evaluation target device.

### BACKGROUND

Recent years have seen the rapid evolution of automobile functions. Examples of the functions include external connection, autonomous driving, automatic control, and in-vehicle infotainment (IVI). The evolution of the functions, the integration of electronic control units (ECUs), the development of software defined vehicles (SDVs) and other similar factors make it more important to address security risks in automobiles. To address security risks in the development of an on-board product, it is required to analyze threats and vulnerabilities and to perform security verification and validation. Note that the validation is also referred to security evaluation, evaluation, or test. In the security verification and the security evaluation, compliance with regulations for on-board devices is mandatory. The security verification and the security evaluation are also important to manage risks in software and a system. The security evaluation is a process of evaluating a security state as a whole. The security evaluation includes a fuzzing test, a vulnerability test, a security function test, and a penetration test.

For example, Patent Literature 1 (PTL 1) discloses a security design support system as an evaluation support system. The security design support system is a system that provides efficient support to a designer who designs the security of an information system. The security design support system includes a security design support device. The security design support device creates a threat list into which security threats that are potential attacks made on the information system, which is an evaluation target, are compiled. The security design support device further creates a countermeasure list into which effective countermeasures against the threats are compiled. The security design support device further creates a test item list into which test items to be performed on the information system equipped with the countermeasures are compiled. Then, based on the threat list, the countermeasure list, and the test item list, the security design support device creates a threat-countermeasure-test-item list in which the threats, the countermeasures, and the test items are associated with one another.

### Citation List

### Patent Literature

PTL 1: Japanese Unexamined Patent Application Publication No. 2024-58377

### SUMMARY

Unfortunately, the above-described security design support system according to PTL 1 can be improved upon.

Hence, the present disclosure provides an evaluation support system and the like capable of improving upon the above related art.

In accordance with an aspect of the present disclosure, an evaluation support system that supports evaluation of an evaluation target device includes: an obtainer that obtains threat analysis information and vulnerability analysis information, the threat analysis information indicating an analysis result of analyzing a threat to information security in the evaluation target device, the vulnerability analysis information indicating an analysis result of analyzing a vulnerability of the information security in the evaluation target device; and an evaluation specification generator that generates evaluation specification information including a plurality of evaluation specifications for the evaluation target device, based on the threat analysis information and the vulnerability analysis information.

Note that such general or specific aspect may be implemented using a device, a method, an integrated circuit, a computer program, or a computer-readable recording medium such as a Compact Disc-Read Only Memory (CD-ROM), or any combination of them. The recording medium may be a non-transitory recording medium.

The evaluation support system according to the present disclosure can be improved upon.

Further merits and advantageous effects in one aspect of the present disclosure will become apparent from the following description and drawings. These merits and advantageous effects are provided by the elements described in the following embodiment, description, and drawings. However, not all of such elements are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of the configuration of a development system in an embodiment.

FIG. 2 is a diagram for describing a part of a threat analysis performed by a threat analyzer in an embodiment as the example.

FIG. 3 is a table showing a schematic example of threat analysis information generated and output by the threat analyzer in the embodiment.

FIG. 4 is a table showing a schematic example of vulnerability analysis information generated and output by a vulnerability analyzer in the embodiment.

FIG. 5 is a table showing a schematic example of vulnerability specification information stored in a vulnerability specification database in the embodiment.

FIG. 6 is a table showing a schematic example of countermeasure specification information stored in a countermeasure specification database in the embodiment.

FIG. 7 is a table showing a schematic example of attack path specification information stored in an attack path specification database in the embodiment.

FIG. 8 is a table showing a schematic example of evaluation tool information stored in an evaluation tool database in the embodiment.

FIG. 9 is a diagram for describing an example of a process in which an evaluation specification generator in the embodiment searches the attack path specification information for an evaluation specification.

FIG. 10 is a diagram for describing an example of a process in which the evaluation specification generator in the embodiment searches the countermeasure specification information for an evaluation specification.

FIG. 11 is a diagram for describing an example of a process in which the evaluation specification generator in the embodiment searches the vulnerability specification information for an evaluation specification.

FIG. 12 is a diagram for describing another example of the process in which the evaluation specification generator in the embodiment searches the vulnerability specification information for an evaluation specification.

FIG. 13 is a diagram for describing still another example of the process in which the evaluation specification generator in the embodiment searches the vulnerability specification information for an evaluation specification.

FIG. 14 is a diagram for describing an example of a process in which the evaluation specification generator in the embodiment generates a detailed procedure.

FIG. 15 is a table showing a schematic example of evaluation specification information that is generated and output by the evaluation specification generator in the embodiment.

FIG. 16 is a table showing a schematic example of evaluated specification information that is provided from an evaluation database in the embodiment to the threat analyzer and the vulnerability analyzer as feedback.

FIG. 17 is a sequence diagram illustrating an example of a processing operation of the development system in the embodiment.

FIG. 18 is a flowchart illustrating an example of a processing operation of an evaluation support system in the embodiment.

FIG. 19 is a table showing a specific example of the threat analysis information in the embodiment.

FIG. 20 is a table showing a specific example of the vulnerability analysis information in the embodiment.

FIG. 21 is a table showing a specific example of the attack path specification information in the embodiment.

FIG. 22 is a table showing a specific example of the countermeasure specification information in the embodiment.

FIG. 23 is a table showing a specific example of the vulnerability specification information in the embodiment.

FIG. 24 is a table showing a specific example of the evaluation tool information in the embodiment.

FIG. 25 is a table showing a specific example of a part of the evaluated specification information in the embodiment.

FIG. 26 is a table showing a specific example of the rest of the evaluated specification information in the embodiment.

### DESCRIPTION OF EMBODIMENT

### Underlying Knowledge Forming Basis of the Present Disclosure

Regarding the security design support system according to PTL 1 described in the section "Background Art," the present inventors found that the following problem arises.

For the security design support system according to PTL 1, no consideration is given to vulnerabilities of an evaluation target device, which is the information system. The resulting problem is that there is the possibility of failing to evaluate the evaluation target device appropriately. For example, necessary evaluations may be missed.

The evaluation support system according to a first aspect of the present disclosure supports evaluation of an evaluation target device, and includes: an obtainer that obtains threat analysis information and vulnerability analysis information, the threat analysis information indicating an analysis result of analyzing a threat to information security in the evaluation target device, the vulnerability analysis information indicating an analysis result of analyzing a vulnerability of the information security in the evaluation target device; and an evaluation specification generator that generates evaluation specification information including a plurality of evaluation specifications for the evaluation target device, based on the threat analysis information and the vulnerability analysis information.

The evaluation specification information including the plurality of evaluation specifications for the evaluation target device is thus generated based on the threat analysis information and the vulnerability analysis information. Accordingly, the evaluation specification information thus generated covers not only the analysis results of analyzing threats to the evaluation target device but also the analysis results of analyzing vulnerabilities of the evaluation target device, thus making it possible to improve the coherence of processes from the analysis of threats and vulnerabilities to the generation of the evaluation specification information. The evaluation specification information also makes it possible to increase the possibility of evaluating the evaluation target device comprehensively while preventing necessary evaluations from being missed. That is, the evaluation specification information makes it possible to decrease the possibility that security evaluations of the evaluation target device become incomplete. Furthermore, the generation of the evaluation specification information is automatic, thus making it possible to reduce human-hours to generate the evaluation specification information. As a result, the evaluations of the evaluation target device can be supported more effectively.

Unfortunately, the above-described security design support system according to PTL 1 is insufficient for supporting evaluation (i.e., tests) of an evaluation target device, which is the information system. Hence, the present disclosure provides an evaluation support system and the like capable of supporting evaluation of an evaluation target device more effectively.

The evaluation support system according to a second aspect of the present disclosure may further include: a database that stores security specification information indicating a plurality of security elements and evaluation specifications in association with each other, wherein the evaluation specification generator: searches the security specification information to obtain one or more first evaluation specifications associated with one or more security elements indicated in the threat analysis information as the analysis result of analyzing a threat; and searches the security specification information to obtain one or more second evaluation specifications associated with one or more security elements indicated in the vulnerability analysis information as the analysis result of analyzing a vulnerability, and in the generation of the evaluation specification information, the evaluation specification generator generates the evaluation specification information including a plurality of evaluation specifications that are the one or more first evaluation specifications and the one or more second evaluation specifications each obtained from the security specification information in the searching. Note that the second aspect may depend from the first aspect.

Thus, the evaluation specifications based on both the analysis results of analyzing threats and the analysis results of analyzing vulnerabilities are obtained from the security specification information in searching, and the evaluation specification information including the evaluation specifications is generated, which enables a plurality of appropriate evaluation specifications to be easily added to the evaluation specification information.

In the evaluation support system according to a third aspect of the present disclosure, it is possible that the database includes a vulnerability specification database that stores vulnerability specification information included in the security specification information, the vulnerability specification information indicates a plurality of vulnerabilities as the plurality of security elements, the vulnerability analysis information indicates, as the one or more security elements, one or more vulnerabilities included in the evaluation target device, the evaluation specification generator searches the vulnerability specification information for one or more evaluation specifications associated with the one or more vulnerabilities, and in the generation of the evaluation specification information, the evaluation specification generator generates the evaluation specification information including the one or more evaluation specifications obtained from the vulnerability specification information in the searching. Note that the third aspect may depend from the second aspect.

Thus, the evaluation specifications based on the vulnerabilities included in the evaluation target device are obtained from the vulnerability specification information in the searching, and the evaluation specification information including the evaluation specifications is generated, which enables evaluation specifications appropriate for the vulnerabilities included in the evaluation target device to be easily added to the evaluation specification information.

In the evaluation support system according to a fourth aspect of the present disclosure, it is possible that the database includes an attack path specification database that stores attack path specification information included in the security specification information, the attack path specification information indicates a plurality of attack paths as the plurality of security elements, the threat analysis information indicates, as the one or more security elements, one or more attack paths in the evaluation target device, the evaluation specification generator searches the attack path specification information for one or more evaluation specifications associated with the one or more attack paths, and in the generation of the evaluation specification information, the evaluation specification generator generates the evaluation specification information including the one or more evaluation specifications obtained from the attack path specification information in the searching. Note that the fourth aspect may depend from the second aspect or the third aspect.

Thus, the evaluation specifications based on the one or more attack paths in the evaluation target device are obtained from the attack path specification information in the searching, and the evaluation specification information including the evaluation specifications is generated, which enables evaluation specifications appropriate for the attack paths in the evaluation target device to be easily added to the evaluation specification information.

In the evaluation support system according to a fifth aspect of the present disclosure, it is possible that the database includes a countermeasure specification database that stores countermeasure specification information included in the security specification information, the countermeasure specification information indicates a plurality of countermeasures as the plurality of security elements, the threat analysis information indicates, as the one or more security elements, one or more countermeasures against one or more threats to the evaluation target device, the evaluation specification generator searches the countermeasure specification information for one or more evaluation specifications associated with the one or more countermeasures, and in the generation of the evaluation specification information, the evaluation specification generator generates the evaluation specification information including the one or more evaluation specifications obtained from the countermeasure specification information in the searching. Note that the fifth aspect may depend from any one of the second to the fourth aspects.

Thus, the evaluation specifications based on the countermeasures against the one or more threats to the evaluation target device are obtained from the countermeasure specification information in the searching, and the evaluation specification information including the evaluation specifications is generated, which enables evaluation specifications appropriate for the countermeasures against the threats to the evaluation target device to be easily added to the evaluation specification information.

The evaluation support system according to a sixth aspect of the present disclosure may further include: an evaluation tool database that stores evaluation tool information indicating a plurality of conditions and evaluation tools in association with each other, wherein the evaluation specification generator searches the evaluation tool information for an evaluation tool associated with a condition which the analysis result indicated in the threat analysis information satisfies, and in the generation of the evaluation specification information, the evaluation specification generator generates the evaluation specification information including an evaluation specification using the evaluation tool obtained from the evaluation tool information in the searching, the evaluation specification being included in the plurality of evaluation specifications. Note that the sixth aspect may depend from any one of the first to the fifth aspects.

Thus, the evaluation specification information including the evaluation specifications using the evaluation tools based on the analysis results of analyzing the threats is generated, which enables evaluation specifications according to which evaluations can be appropriately executed to be easily added to the evaluation specification information.

In the evaluation support system according to a seventh aspect of the present disclosure, it is possible that, in the generation of the evaluation specification information, the evaluation specification generator: generates, by using a function and an attack path each indicated in the threat analysis information as the analysis result, a procedure for evaluation of the evaluation target device; and adds the procedure generated to at least one of the plurality of evaluation specifications. Note that the seventh aspect may depend from any one of the first to sixth aspects.

A procedure for evaluation is thus added to an evaluation specification as, for example, a detailed procedure, making it possible to increase the possibility that an evaluating person can perform appropriate evaluations without hesitation by referring to the detailed procedure. In addition, for example, by generating a detailed procedure for each commodity, which is the evaluation target device, an evaluation can be performed appropriately on each commodity.

In the evaluation support system according to an eighth aspect of the present disclosure, it is possible that each of the plurality of evaluation specifications includes a criterion for an evaluation result of the evaluation target device. Note that the eighth aspect may depend from any one of the first to the seventh aspects.

Each of the evaluation specifications includes a criterion as, for example, a determination criterion. Thus, in a case where the evaluation is performed according to the evaluation specifications, it is easy to determine whether an evaluation result is OK or NG using the determination criterion.

In the evaluation support system according to a ninth aspect of the present disclosure, it is possible that the evaluation specification generator further determines a priority of each of the plurality of evaluation specifications obtained from the security specification information in the searching. Note that the ninth aspect may depend from the second aspect or from any one of the third to eighth aspects which depend from the second aspect.

Thus, referring to the priorities of the plurality of evaluation specifications, the evaluating person can easily determine an evaluation specification based on which to execute an evaluation first and an evaluation specification based on which to execute an evaluation later. Accordingly, an important evaluation can be executed first to prevent the important evaluation from being executed later.

In the evaluation support system according to a tenth aspect of the present disclosure, it is possible that the security specification information indicates, for each of the evaluation specifications, a technical level, an evaluation time period, and an influence degree by numerical values, and in the determination of the priority, for each of the plurality of evaluation specifications obtained from the security specification information in the searching, the evaluation specification generator: identifies, from the security specification information, a technical level, an evaluation time period, and an influence degree each corresponding to the evaluation specification; and determines the priority by performing weighted addition of the technical level identified, the evaluation time period identified, and the influence degree identified. Note that the tenth aspect may depend from the ninth aspect.

Thus, the priority of an evaluation specification is determined by performing the weighted addition on the technical level, evaluation time period, and influence degree of the evaluation specification. Accordingly, for example, increasing the weight for technical level enables the priority to be determined mainly from the viewpoint of technical level, and increasing the weight for evaluation time period enables the priority to be determined mainly from the viewpoint of evaluation time period. Alternatively, increasing the weight for influence degree enables the priority to be determined mainly from the viewpoint of influence degree (e.g., quality). In addition, for example, by adjusting the weights for each commodity, which is the evaluation target device, the priority can be determined appropriately for the commodity.

The evaluation support system according to an eleventh aspect of the present disclosure may further include: a feedback provider that provides, to a threat analyzer and a vulnerability analyzer, evaluated specification information, as feedback, the evaluated specification information being the evaluation specification information indicating an evaluation result of the evaluation target device, the evaluation result being obtained by evaluation based on the evaluation specification information, wherein the threat analyzer generates the threat analysis information by analyzing a threat to the evaluation target device, and the vulnerability analyzer generates the vulnerability analysis information by analyzing a vulnerability of the evaluation target device. Note that the eleventh aspect may depend from any one of the first to tenth aspects. Note that the evaluation result may be expressed as a determination result, such as OK or NG.

The evaluated specification information is thus provided to the threat analyzer and the vulnerability analyzer as feedback. Accordingly, the threat analyzer can guarantee the analysis result of analyzing a threat with regard to an evaluation specification about which a favorable evaluation result is indicated in the evaluated specification information. For example, in a case where the analysis result is about a countermeasure to the threat, the threat analyzer can guarantee the effectiveness of the countermeasure. With regard to an evaluation specification about which an unfavorable evaluation result is indicated in the evaluated specification information, the threat analyzer can improve its threat analysis. For example, in a case where the analysis result is about a countermeasure to the threat, the threat analyzer can improve the countermeasure. As a result, the accuracy of formulating the countermeasure can be increased. The vulnerability analyzer can increase the accuracy of its vulnerability analysis based on the evaluation results indicated in the evaluated specification information. That is, in the eleventh aspect, the evaluation support system not only provides a one-way traffic from the threat analysis and vulnerability analysis to the evaluation but also provides the evaluation result to the threat analysis and vulnerability analysis as feedback, thus enabling the risk management of the evaluation target device to be performed effectively.

An evaluation support method according to a twelfth aspect of the present disclosure supports evaluation of an evaluation target device and includes: obtaining threat analysis information and vulnerability analysis information, the threat analysis information indicating an analysis result of analyzing a threat to information security in the evaluation target device, the vulnerability analysis information indicating an analysis result of analyzing a vulnerability of the information security in the evaluation target device; and generating evaluation specification information including a plurality of evaluation specifications for the evaluation target device, based on the threat analysis information and the vulnerability analysis information.

It is thus possible to provide the same advantageous effects as with the evaluation support system according to the first aspect.

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps, etc. shown in the following exemplary embodiment are mere examples, and therefore do not limit the scope of the present disclosure. Therefore, among the elements in the following exemplary embodiment, those not recited in any one of the independent claims are described as optional elements.

Also note that the drawings are schematic diagrams, and thus they are not always exactly illustrated. Also, the same elements are assigned the same reference marks throughout the drawings.

### Embodiment

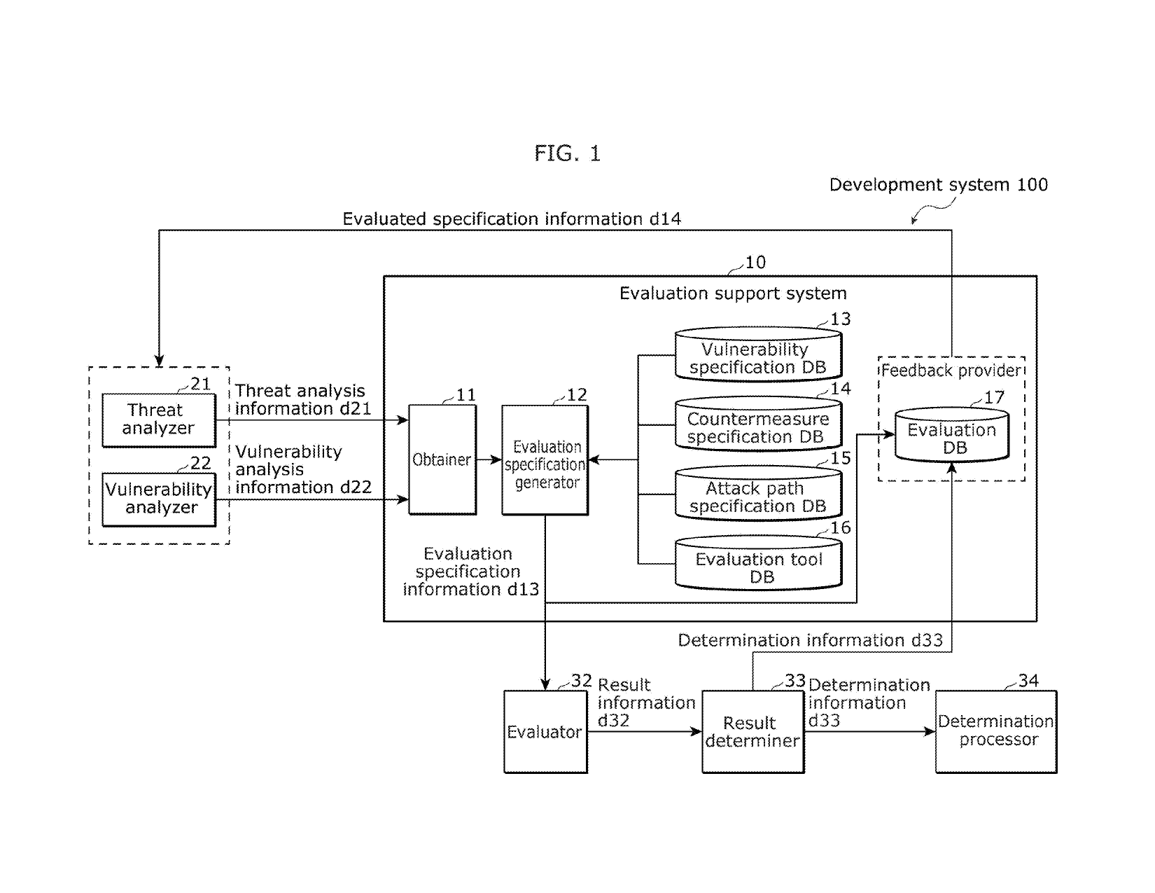

FIG. 1 is a diagram illustrating an example of the configuration of a development system in the present embodiment.

Development system 100 in the present embodiment is a system that supports the development of an evaluation target device (e.g., a product or a commodity) such as an electronic control unit (ECU) to be installed in vehicles. Note that development system 100 may be a system for complying with regulations in International Organization for Standardization (ISO)/Society of Automotive Engineers (SAE) 21434. Development system 100 includes threat analyzer 21, vulnerability analyzer 22, evaluator 32, result determiner 33, determination processor 34, and evaluation support system 10.

Threat analyzer 21 generates threat analysis information d21 by analyzing a threat to the evaluation target device. Threat analysis information d21 indicates the analysis result of analyzing a threat to information security in the evaluation target device. For example, threat analyzer 21 identifies an attack path from analyzing the threat and formulates a countermeasure to the threat. Threat analyzer 21 then generates threat analysis information d21 indicating the attack path, the countermeasure, and the like. Threat analyzer 21 may evaluate the evaluation target device by identifying a threat that may confront the evaluation target device. The threat includes any element that may compromise the security of the evaluation target device, such as a malicious attacker or a natural disaster. Note that the attack path, the countermeasure, and the like described above are an example of security elements.

Vulnerability analyzer 22 generates and outputs vulnerability analysis information d22 by analyzing a vulnerability of the evaluation target device. Vulnerability analysis information d22 indicates the analysis result of analyzing a vulnerability of the information security in the evaluation target device. For example, vulnerability analyzer 22 determines, for each of vulnerabilities, whether the evaluation target device has the vulnerability, thus generating vulnerability analysis information d22 indicating the result of the determination. That is, vulnerability analysis information d22 indicates vulnerabilities of the evaluation target device. Vulnerability analyzer 22 may identify a vulnerability present in the evaluation target device and evaluate the vulnerability. Note that a vulnerability may be considered to be a weakness of the evaluation target device in defending against an attack. Vulnerability analyzer 22 may also identify the severity of a vulnerability as a vulnerability analysis. The severity is, for example, a score according to common vulnerability scoring system (CVSS). Note that the vulnerability or the like described above is an example of a security element.

Evaluator 32 obtains evaluation specification information d13 generated by evaluation support system 10 and performs evaluations (i.e., tests) of the evaluation target device according to evaluation specification information d13. Evaluator 32 then outputs information indicating the results of the evaluations as result information d32. For example, result information d32 indicates, for each of evaluation items, the result of the evaluation as to the evaluation item. Note that the evaluations of the evaluation target device are evaluations as to a security state. Examples of the evaluations include a fuzzing test, a vulnerability test, a security function test, and a penetration test. Evaluation specifications in the present embodiment are specifications for performing these evaluations.

Result determiner 33 obtains result information d32 output from evaluator 32 and makes a determination of the result of the evaluation as to each evaluation item indicated by result information d32, thus generating determination information d33 indicating the results of the determinations. Determination information d33 indicates whether the result of the evaluation as to each evaluation item is, for example, OK or NG. Note that OK indicates the result of the evaluation is as expected or is to specifications. NG indicates that the result of the evaluation is not OK, indicating that the result of the evaluation is not as expected or is not to specifications. The result of the determination such as OK or NG according to determination information d33 is also referred to as a test result. Result determiner 33 then outputs determination information d33 to evaluation support system 10 and determination processor 34.

Determination processor 34 obtains determination information d33 output from result determiner 33 and outputs an NG report about one or more evaluation items determined to be NG and the results of the evaluations indicated by determination information d33. Determination processor 34 may also propose an improvement plan for a countermeasure relating to an evaluation item determined to be NG.

Evaluation support system 10 in the present embodiment is an evaluation support system that supports evaluations of the evaluation target device. Evaluation support system 10 generates evaluation specification information d13 based on threat analysis information d21 and vulnerability analysis information d22. Evaluation support system 10 then provides, as feedback, evaluated specification information d14 including evaluation specification information d13 together with determination information d33 described above, to threat analyzer 21 and vulnerability analyzer 22.

Such evaluation support system 10 includes obtainer 11, evaluation specification generator 12, vulnerability specification database 13, countermeasure specification database 14, attack path specification database 15, evaluation tool database 16, and evaluation database 17. Note that each of the databases will also be denoted as a DB.

Obtainer 11 obtains one or more pieces of threat analysis information d21 from threat analyzer 21 and outputs the one or more pieces of threat analysis information d21 to evaluation specification generator 12. Obtainer 11 further obtains one or more pieces of vulnerability analysis information d22 from vulnerability analyzer 22 and outputs the one or more pieces of vulnerability analysis information d22 to evaluation specification generator 12. The one or more obtained pieces of threat analysis information d21 each indicate an analysis result of analyzing a threat to information security in evaluation target device 40. That is, the one or more pieces of threat analysis information d21 each indicate, as the analysis result, one or more security elements such as an attack path and a countermeasure. The one or more obtained pieces of vulnerability analysis information d22 each indicate an analysis result of analyzing a vulnerability of the information security in evaluation target device 40. That is, the one or more pieces of vulnerability analysis information d22 each indicate, as the analysis result, one or more security elements such as a vulnerability.

Evaluation specification generator 12 obtains, from obtainer 11, the one or more pieces of threat analysis information d21 and the one or more pieces of vulnerability analysis information d22 and generates evaluation specification information d13 based on the one or more pieces of threat analysis information d21 and the one or more pieces of vulnerability analysis information d22. At this time, evaluation specification generator 12 generates evaluation specification information d13 with reference to information stored in vulnerability specification database 13, countermeasure specification database 14, attack path specification database 15, and evaluation tool database 16. Evaluation specification generator 12 outputs generated evaluation specification information d13 to evaluator 32 and evaluation database 17.

Vulnerability specification database 13 is a recording medium that stores pieces of vulnerability specification information indicating a plurality of vulnerabilities and evaluation specifications in association with each other. Countermeasure specification database 14 is a recording medium that stores pieces of countermeasure specification information indicating a plurality of countermeasures and evaluation specifications in association with each other. Note that each of the plurality of countermeasures is a countermeasure against the threat described above. Attack path specification database 15 is a recording medium that stores pieces of attack path specification information indicating a plurality of attack paths and evaluation specifications in association with each other. Evaluation tool database 16 is a recording medium that stores pieces of evaluation tool information indicating a plurality of conditions and evaluation tools in association with each other. Each of the plurality of conditions is a condition required of an evaluation specification.

Note that vulnerability specification database 13, countermeasure specification database 14, and attack path specification database 15 may be considered to constitute one database. The one database stores security specification information indicating a plurality of security elements and evaluation specifications in association with each other. The plurality of security elements include the plurality of vulnerabilities, plurality of countermeasures, and plurality of attack paths described above.

Evaluation database 17 is a recording medium that stores evaluation specification information d13 and the like. Evaluation database 17 also stores evaluated specification information d14. That is, result determiner 33 stores determination information d33 in evaluation database 17. At this time, result determiner 33 generates evaluated specification information d14 by adding determination information d33 to evaluation specification information d13 that has already been stored in evaluation database 17. Evaluated specification information d14 is thus stored in evaluation database 17. Evaluated specification information d14 stored in evaluation database 17 is provided, as feedback, to threat analyzer 21 and vulnerability analyzer 22. That is, evaluation database 17 in the present embodiment is configured as a feedback provider that provides, as feedback, evaluation specification information d13 indicating the evaluation results of the evaluation target device that are obtained by evaluations based on evaluation specification information d13, as evaluated specification information d14 to threat analyzer 21 and vulnerability analyzer 22.

Note that the above-described databases in the present embodiment are implemented with a hard disk drive, a random access memory (RAM), a read only memory (ROM), a semiconductor memory, or the like. Note that such databases may be either volatile or nonvolatile.

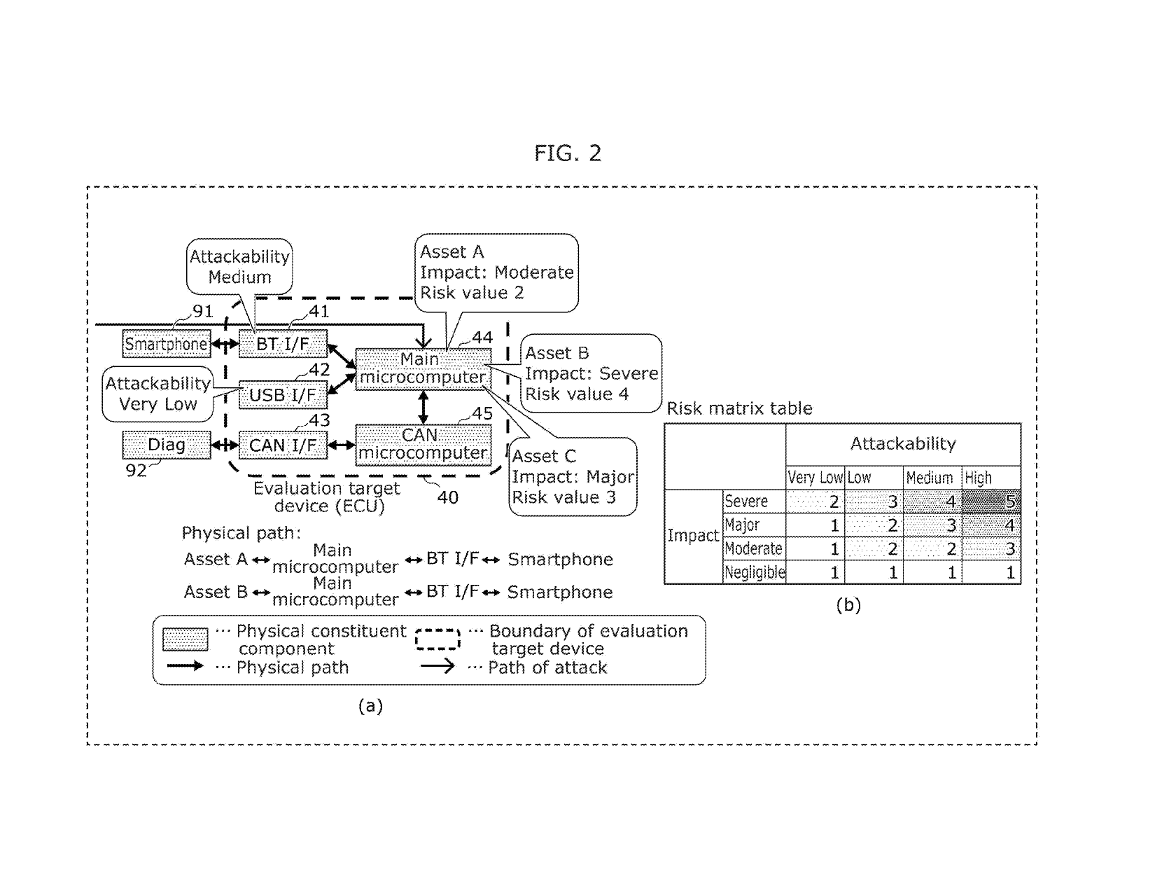

FIG. 2 is a diagram for describing a part of a threat analysis performed by threat analyzer 21 as an example.

As illustrated in (a) in FIG. 2, threat analyzer 21 may evaluate, for example, asset A, asset B, and asset C possessed by evaluation target device 40 in the form of their risk values. Asset A, asset B, and asset C are each data, a function, or the like to be protected in evaluation target device 40. Note that the function is implemented in the form of, for example, a program. Evaluation target device 40 is configured as, for example, an ECU to be installed in a vehicle and communicates with external devices such as smartphone 91 and Diag 92 in a wireless or wired manner. Note that smartphone 91 refers to a mobile phone or a cell phone, and Diag 92 refers to a device for diagnosing a defect, a malfunction, or the like of a vehicle, that is, a diagnosis. Such evaluation target device 40 includes BT interface 41, USB interface 42, CAN interface 43, Main microcomputer 44, and CAN microcomputer 45, each of which is a physical constituent component. BT interface 41, which is an interface for Bluetooth (Registered Trademark), is also denoted as a BT I/F. USB interface 42, which is an interface for universal serial bus (USB), is also denoted as a USB I/F. CAN interface 43, which is an interface for controller area network (CAN), is also denoted as a CAN I/F. Main microcomputer 44 is a microcomputer that controls evaluation target device 40. Main microcomputer 44 possesses asset A, asset B, and asset C described above. CAN microcomputer 45 is a microcomputer that controls the CAN in evaluation target device 40. Note that the physical constituent components are hardware constituent components.

Here, there are physical paths between Main microcomputer 44, and BT interface 41, USB interface 42, and CAN microcomputer 45. There is also a physical path between BT interface 41 and smartphone 91. There is also a physical path between CAN microcomputer 45 and CAN interface 43, and there is also a physical path between CAN interface 43 and Diag 92. Note that the physical paths are physical connection paths.

Each of the physical constituent components may be assigned a level of attackability (attackability level). For example, BT interface 41 is assigned Medium as the attackability level. USB interface 42 is assigned Very Low as the attackability level.

To each of the assets, an impact level that an attack on the asset will evaluate target device 40 is set. For example, to asset A, Moderate is set as the impact level, to asset B, Severe is set as the impact level, and to asset C, Major is set as the impact level.

For each of asset A, asset B, and asset C, threat analyzer 21 determines the path of an attack to the asset. That is, threat analyzer 21 determines, for each of asset A, asset B, and asset C, a physical path constituted of an array of one or more physical constituent components from an external device to the asset. In a case where there are a plurality of paths of an attack to an asset, threat analyzer 21 determines one path of an attack from among the plurality of paths of an attack. Note that the path of an attack is also referred to as an attack path.

For example, in a case where smartphone 91 attacks asset A, asset B, and asset C, smartphone 91 is likely to access Main microcomputer 44 via BT interface 41, which is assigned the attackability level "Medium." Alternatively, smartphone 91 is likely to access Main microcomputer 44 via USB interface 42, which is assigned the attackability level "Very Low." That is, the paths of an attack on asset A, asset B, and asset C include a path of an attack via BT interface 41 and a path of an attack via USB interface 42. In this case, threat analyzer 21 determines a path of an attack via a physical constituent component that is assigned the highest attackability level. In a case of the example described above, the highest attackability level is Medium. Therefore, the path of an attack determined by threat analyzer 21 indicates a physical path from smartphone 91 via BT interface 41 to Main microcomputer 44. Note that threat analyzer 21 may determine all paths of an attack on an asset as well as the path of an attack via a physical constituent component that is assigned the highest attackability level.

Threat analyzer 21 derives the risk value of the asset using the attackability level "Medium" and the impact level of the asset with reference to a risk matrix table shown in (b) in FIG. 2, thus evaluating the risk value.

As shown in (b) in FIG. 2, the risk matrix table shows, for each combination of an attackability level and an impact level, a risk value corresponding to the combination. The attackability levels are classified as Very Low, Low, Medium, and High. Note that these levels are arrayed in ascending order. The impact levels are classified as Severe, Major, Moderate, and Negligible. Note that these levels are arrayed in descending order.

In the example described above, the impact level on asset A is Moderate, the impact level on asset B is Severe, and the impact level on asset C is Major. The attackability level of the paths of an attack to these assets is Medium. That is, the highest attackability level over the paths of an attack, that is, the physical path to the assets is Medium. Therefore, referring to the risk matrix table, threat analyzer 21 derives "2" as the risk value of asset A, derives "4" as the risk value of asset B, and derives "3" as the risk value of asset C. The risk values of asset A, asset B, and asset C are thus evaluated. Note that the impact level, the attackability level, and the risk matrix table are defined in, for example, ISO 21434.

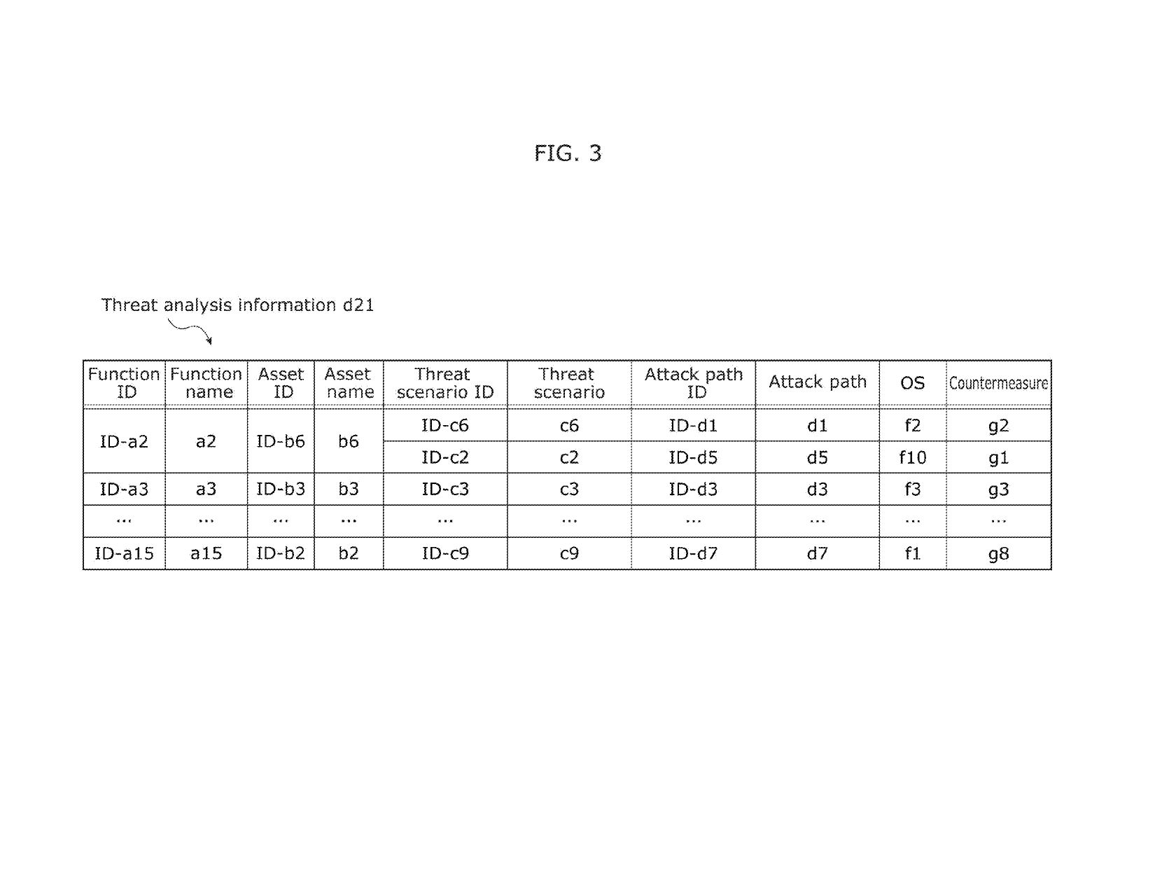

FIG. 3 is a table showing a schematic example of threat analysis information d21 generated and output by threat analyzer 21.

As shown in FIG. 3, threat analysis information d21 generated by threat analyzer 21 indicates, for example, function ID, function name, asset ID, asset name, threat scenario ID, threat scenario, attack path ID, attack path, operating system (OS), and countermeasure in association with one another. The function ID is information for identifying a function of evaluation target device 40 (i.e., identification information), and the function name is the name of the function. The asset ID is information for identifying an asset associated with the function, and the asset name is the name of the asset. The threat scenario is a scenario of a threat to the asset, and the threat scenario ID is information for identifying the threat scenario. The attack path (i.e., the path of an attack described above) is an attack path determined for the asset, and the attack path ID is information for identifying the attack path. The OS is software considered to be necessary to execute the function or the asset. The countermeasure is a countermeasure for the attack path and the threat scenario. Note that a plurality of sets of threat scenario IDs and threat scenarios may be associated with the set of a function ID and a function name or the set of an asset ID and an asset name. One set of an attack path ID and an attack path may be associated with the set of a threat scenario ID and a threat scenario, and one OS and one countermeasure may be associated with the set of an attack path ID and an attack path.

In a specific example, threat analysis information d21 indicates the function ID "ID-a2" and the function name "a2," and the asset ID "ID-b6" and the asset name "b6" in association with each other. Threat analysis information d21 further indicates, for the asset ID "ID-b6" and the asset name "b6," the set of the threat scenario ID "ID-c6" and the threat scenario "c6" and the set of the threat scenario ID "ID-c2" and the threat scenario "c2" in association with each other. Threat analysis information d21 further indicates, for the set of the threat scenario ID "ID-c6" and the threat scenario "c6," the set of the attack path ID "ID-d1" and the attack path "d1," the set of the OS "f2," and the countermeasure "g2" in association with one another. The OS "f2" may be Windows (Registered Trademark), Linux (Registered Trademark), or the like. Note that character strings contained in pieces of the information schematically shown in the present embodiment, each of which is constituted of at least one of alphabet letter, numeral, and symbol (more specifically, character strings other than those containing "ID-"), such as "g2," are actually names or phrases.

Note that threat analysis information d21 may include the impact level, risk value, and the like described above.

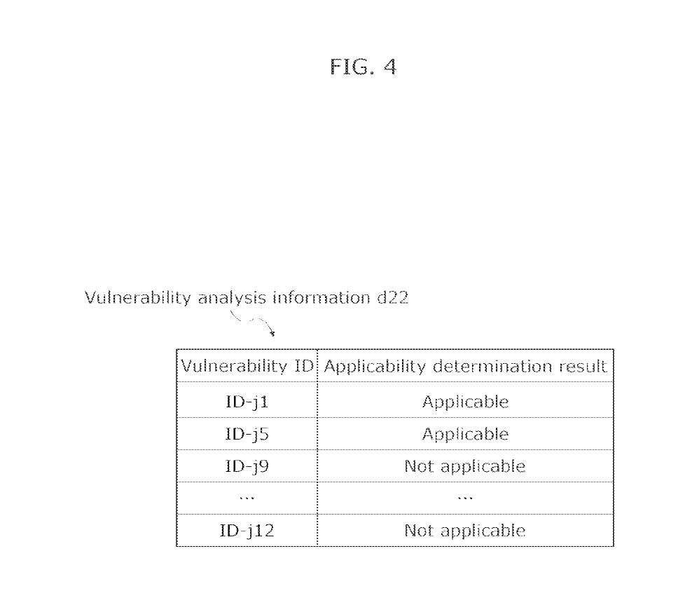

FIG. 4 is a table showing a schematic example of vulnerability analysis information d22 generated and output by vulnerability analyzer 22.

As shown in FIG. 4, vulnerability analysis information d22 generated by vulnerability analyzer 22 indicates, for example, for each vulnerability ID, the vulnerability ID and an applicability determination result as to whether the vulnerability identified with the vulnerability ID applies to evaluation target device 40, in association with each other. The vulnerability ID is information for identifying a vulnerability. For example, the vulnerability ID may be a common weakness enumeration (CWE)-ID. The applicability determination result indicates "applicable" in a case where evaluation target device 40 has the vulnerability, and indicates "not applicable" in a case where evaluation target device 40 does not have the vulnerability. That is, the applicability determination result indicates whether evaluation target device 40 has the vulnerability. In a specific example, vulnerability analysis information d22 indicates the vulnerability ID "ID-j1" and the applicability determination result "applicable" of the vulnerability identified with the vulnerability ID "ID-j1" in association with each other. Note that vulnerability analysis information d22 may indicate the details of the vulnerability.

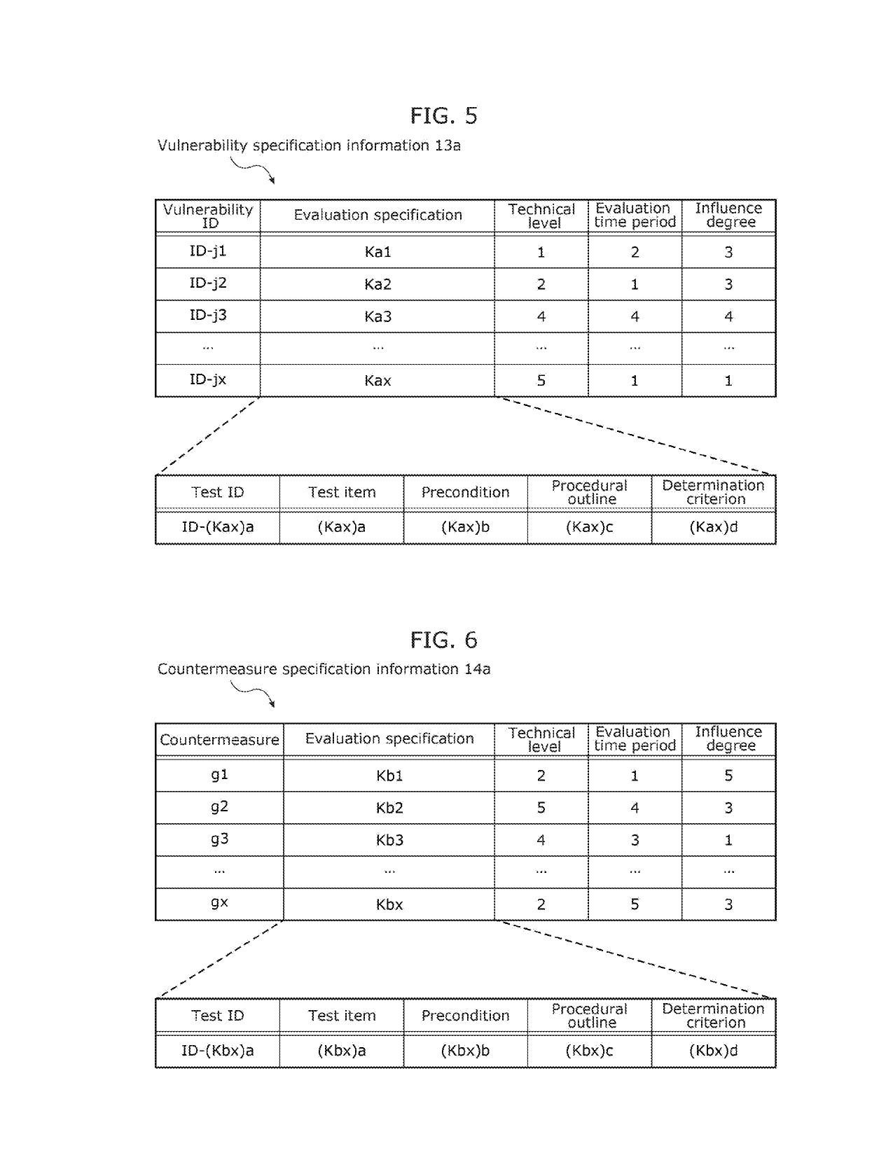

FIG. 5 is a table showing a schematic example of vulnerability specification information stored in vulnerability specification database 13.

Vulnerability specification information 13a stored in vulnerability specification database 13 indicates, for each vulnerability ID, the vulnerability ID, an evaluation specification for the vulnerability identified with the vulnerability ID, and the technical level, evaluation time period, and influence degree of the evaluation specification in association with one another. The technical level is a technical level required of a user for an evaluation of evaluation target device 40 according to the evaluation specification. For example, the technical level is represented by one of the numbers from 1 to 5 (i.e., an integer). Note that the user is, for example, an evaluating person who evaluates evaluation target device 40. A larger number indicates a higher technical level represented by the number (i.e., the evaluation is difficult), and a smaller number indicates a lower technical level represented by the number (i.e., the evaluation is easy). The evaluation time period is a time period it takes to evaluate evaluation target device 40 according to the evaluation specification. For example, the evaluation time period is represented by one of the numbers from 1 to 5 (i.e., an integer). A larger number indicates a longer evaluation time period represented by the number, and a smaller number indicates a shorter evaluation time period represented by the number. The influence degree is the magnitude of an influence that an evaluation of evaluation target device 40 according to the evaluation specification exerts on evaluation target device 40. For example, the influence degree is represented by one of the numbers from 1 to 5 (i.e., an integer). A larger number indicates a larger influence degree represented by the number, and a smaller number indicates a smaller influence degree represented by the number. Note that the influence degree is also considered to be the magnitude of an influence exerted on the quality of evaluation target device 40.

The evaluation specification includes test ID, test item, precondition, procedural outline, and determination criterion. The test item is an item of an evaluation specification. The test item is also referred to as evaluation item. The test ID is information for identifying the evaluation specification or the evaluation item. The precondition is a condition serving as a prerequisite for evaluating evaluation target device 40. The procedural outline is a schematic procedure for evaluating evaluation target device 40. The determination criterion is a criterion for determining, for example, whether the result of an evaluation of evaluation target device 40 is OK or NG. That is, the determination criterion is used in processing performed by result determiner 33.

Note that, in a case where a vulnerability ID indicated in vulnerability specification information 13a is CWE-ID and the CWE-ID is, for example, "CWE-327," the vulnerability identified with "CWE-327" means that an encryption algorithm in use is weak. In this case, an evaluation specification associated with "CWE-327" in vulnerability specification information 13a is also considered to be, for example, a specification of a vulnerability test described later. In a case where a vulnerability ID indicated in vulnerability specification information 13a is CWE-ID and the CWE-ID is, for example, "CWE-248," the vulnerability identified with "CWE-248" means an unhandled exception. In a case where a vulnerability ID indicated in vulnerability specification information 13a is CWE-ID and the CWE-ID is, for example, "CWE-787," the vulnerability identified with "CWE-787" means a buffer overflow. The evaluation specification associated with "CWE-248" or "CWE-787" in vulnerability specification information 13a is also considered to be, for example, a specification of a fuzzing test described later.

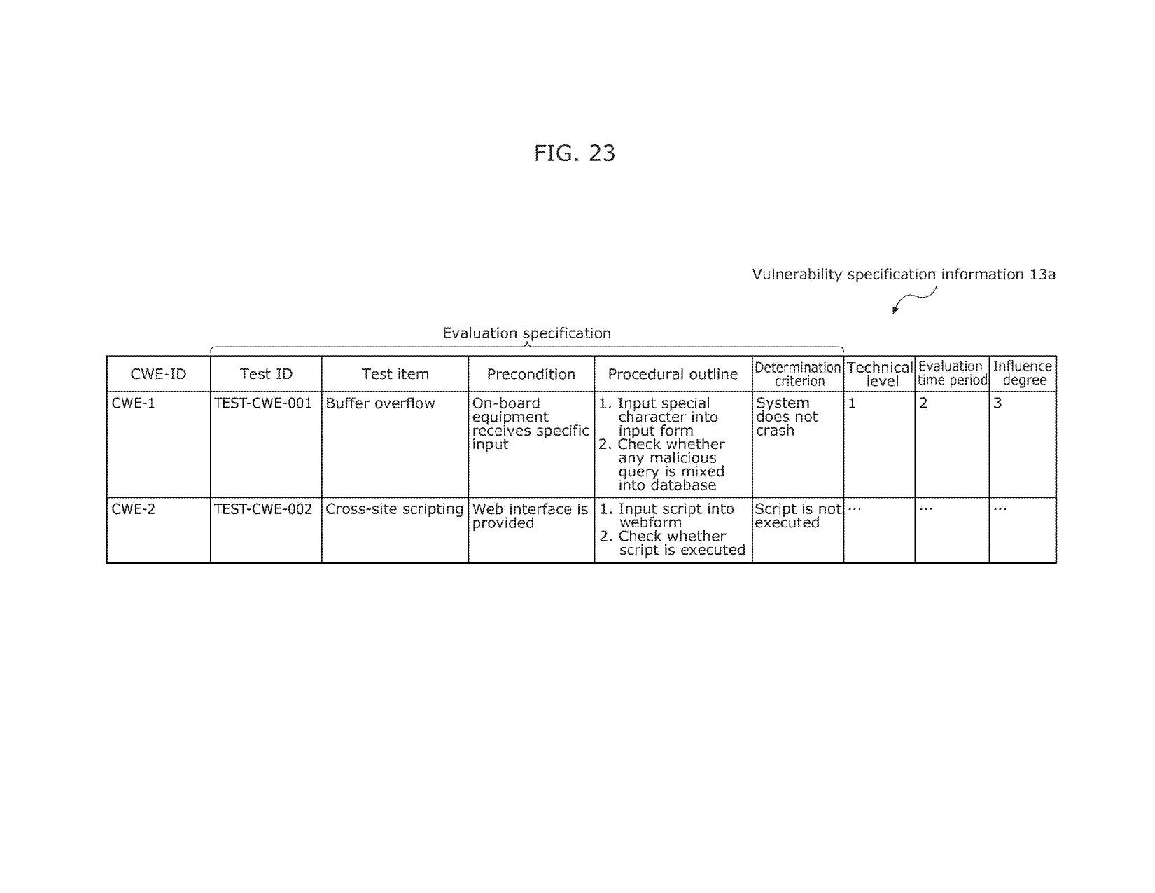

In a specific example, vulnerability specification information 13a indicates the vulnerability ID "ID-jx," the evaluation specification "Kax," the technical level "5," the evaluation time period "1," and the influence degree "1" in association with one another. The evaluation specification "Kax" includes the test ID "ID-(Kax)a," the test item "(Kax)a," the precondition "(Kax)b," the procedural outline "(Kax)c," and the determination criterion "(Kax)d." Note that a more specific example of vulnerability specification information 13a is as shown in FIG. 23.

FIG. 6 is a table showing a schematic example of countermeasure specification information stored in countermeasure specification database 14.

Countermeasure specification information 14a stored in countermeasure specification database 14 indicates, for each countermeasure, the countermeasure, the evaluation specification for the countermeasure, and the technical level, evaluation time period, and influence degree of the evaluation specification in association with one another. Note that each evaluation specification indicated in countermeasure specification information 14a is also considered to be, for example, a specification of a security function test described later.

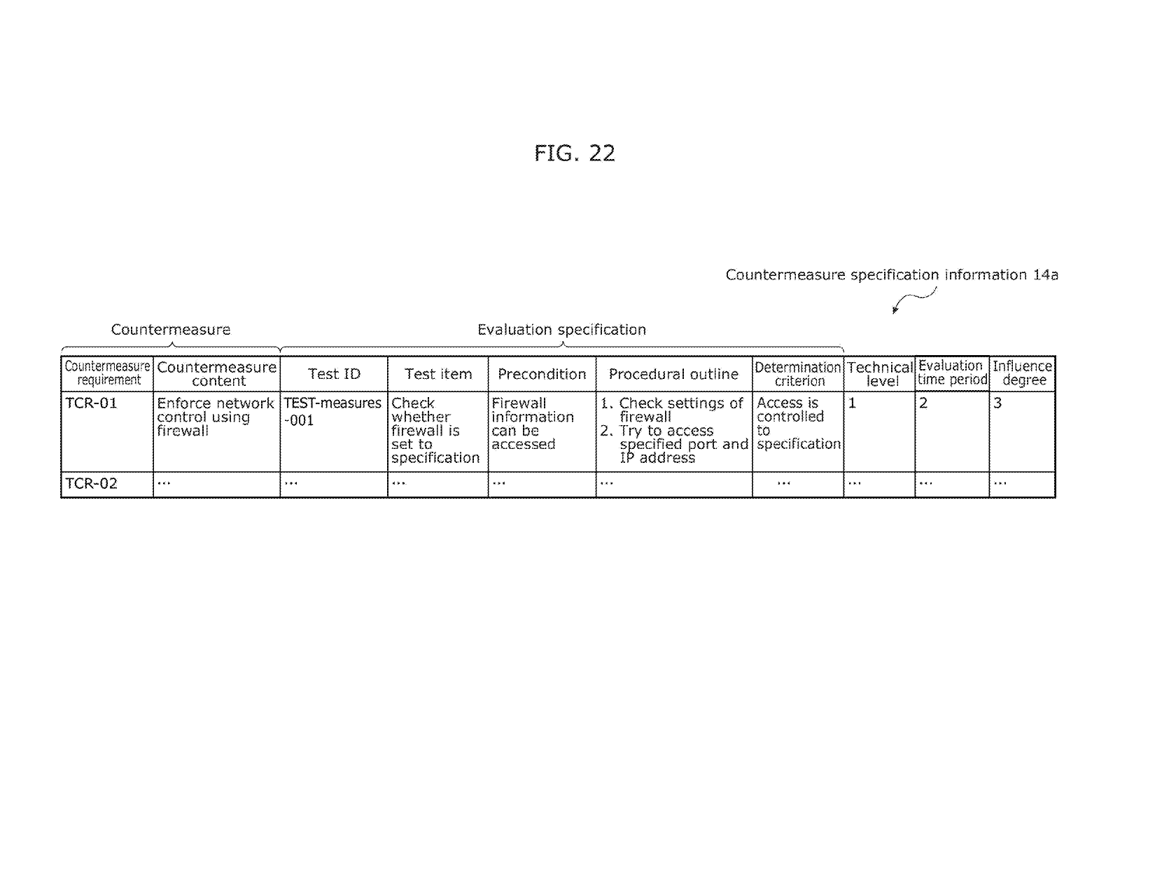

In a specific example, countermeasure specification information 14a indicates the countermeasure "gx," the evaluation specification "Kbx," the technical level "2," the evaluation time period "5," and the influence degree "3" in association with one another. The evaluation specification "Kbx" includes the test ID "ID-(Kbx)a," the test item "(Kbx)a," the precondition "(Kbx)b," the procedural outline "(Kbx)c," and the determination criterion "(Kbx)d." Note that a more specific example of countermeasure specification information 14a is as shown in FIG. 22.

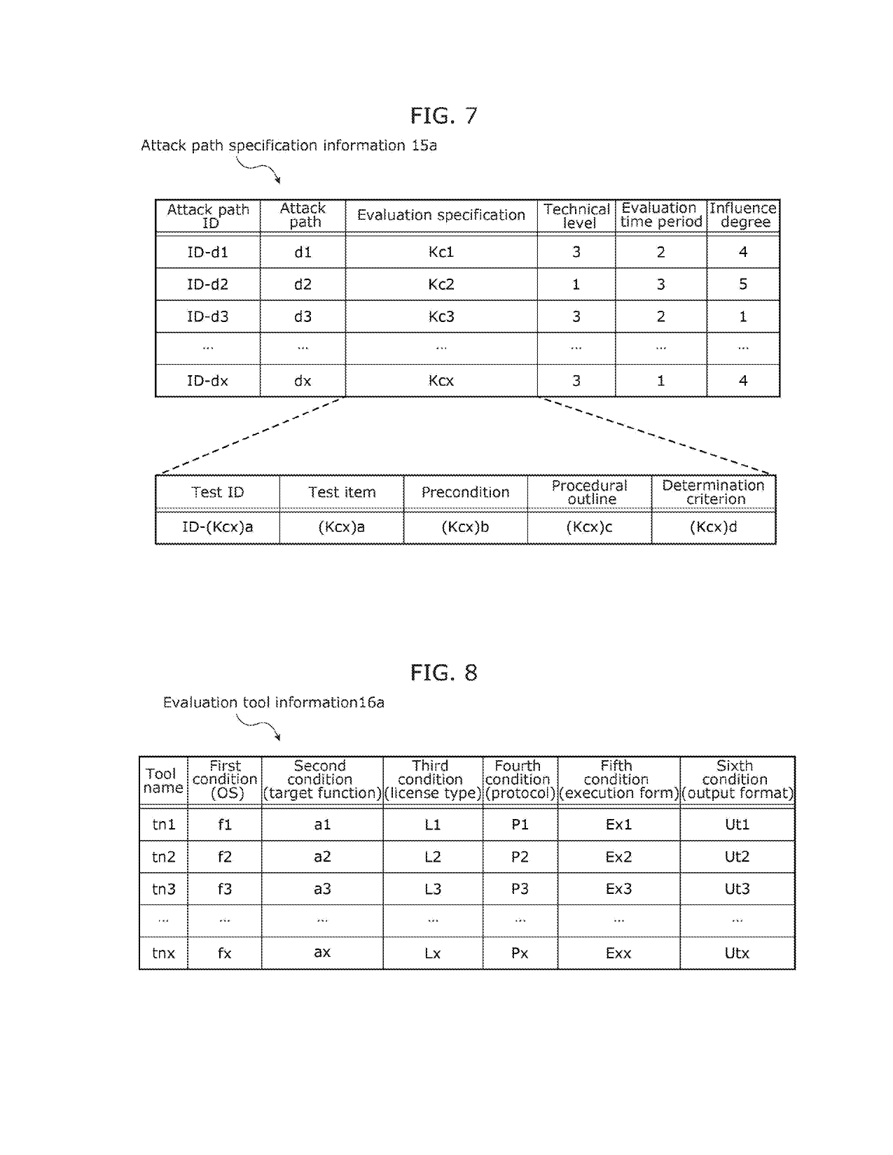

FIG. 7 is a table showing a schematic example of attack path specification information stored in attack path specification database 15.

Attack path specification information 15a stored in attack path specification database 15 indicates, for each set of an attack path ID and an attack path, the set, an evaluation specification for the set, and the technical level, evaluation time period, and influence degree of the evaluation specification in association with one another. Note that each evaluation specification indicated in attack path specification information 15a is also considered to be, for example, a specification of a penetration test described later.

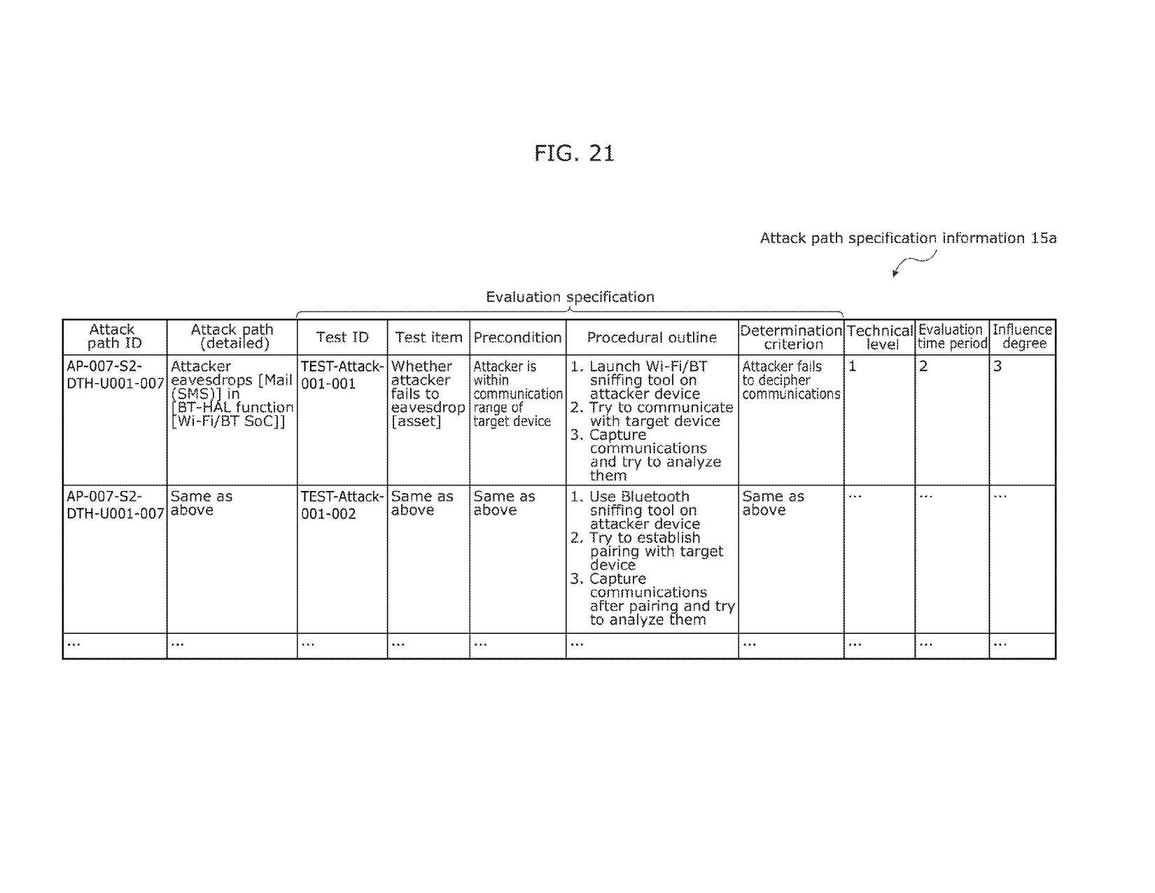

In a specific example, attack path specification information 15a indicates the set of the attack path ID "ID-dx" and the attack path "dx," the evaluation specification "Kcx," the technical level "3," the evaluation time period "1," and the influence degree "4" in association with one another. The evaluation specification "Kcx" includes the test ID "ID-(Kcx)a," the test item "(Kcx)a," the precondition "(Kcx)b," the procedural outline "(Kcx)c," and the determination criterion "(Kcx)d." Note that a more specific example of attack path specification information 15a is as shown in FIG. 21.

FIG. 8 is a table showing a schematic example of evaluation tool information stored in evaluation tool database 16.

Evaluation tool information 16a stored in evaluation tool database 16 indicates, for each evaluation tool to be used for an evaluation of evaluation target device 40, a tool name, which is the name of the evaluation tool, and a group of conditions for using the evaluation tool in association with each other. The group of conditions is constituted of a first condition, a second condition, a third condition, a fourth condition, a fifth condition, and a sixth condition.

The first condition is a condition pertaining to an OS considered to be necessary to execute a function of evaluation target device 40. The first condition indicates one or more types of OS on which the evaluation tool can be used, such as Linux (Registered Trademark). The second condition is a condition pertaining to a function of evaluation target device 40 (i.e., a target function). The second condition indicates one or more functions with which the evaluation tool can be used, such as CAN. The third condition is a condition pertaining to a license type of a function of evaluation target device 40. The third condition indicates one or more license types under which the evaluation tool can be used, such as an open-source license. The fourth condition is a condition pertaining to a protocol of a function of evaluation target device 40. The fourth condition indicates one or more protocols under which the evaluation tool can be used, such as transmission control protocol (TCP). The fifth condition is a condition pertaining to an execution form of a function of evaluation target device 40. The fifth condition indicates one or more execution forms with which the evaluation tool can be used, such as graphical user interface (GUI). The sixth condition is a condition pertaining to an output format of a function of evaluation target device 40. The sixth condition indicates one or more output formats with which the evaluation tool can be used, such as extensible markup language (XML).

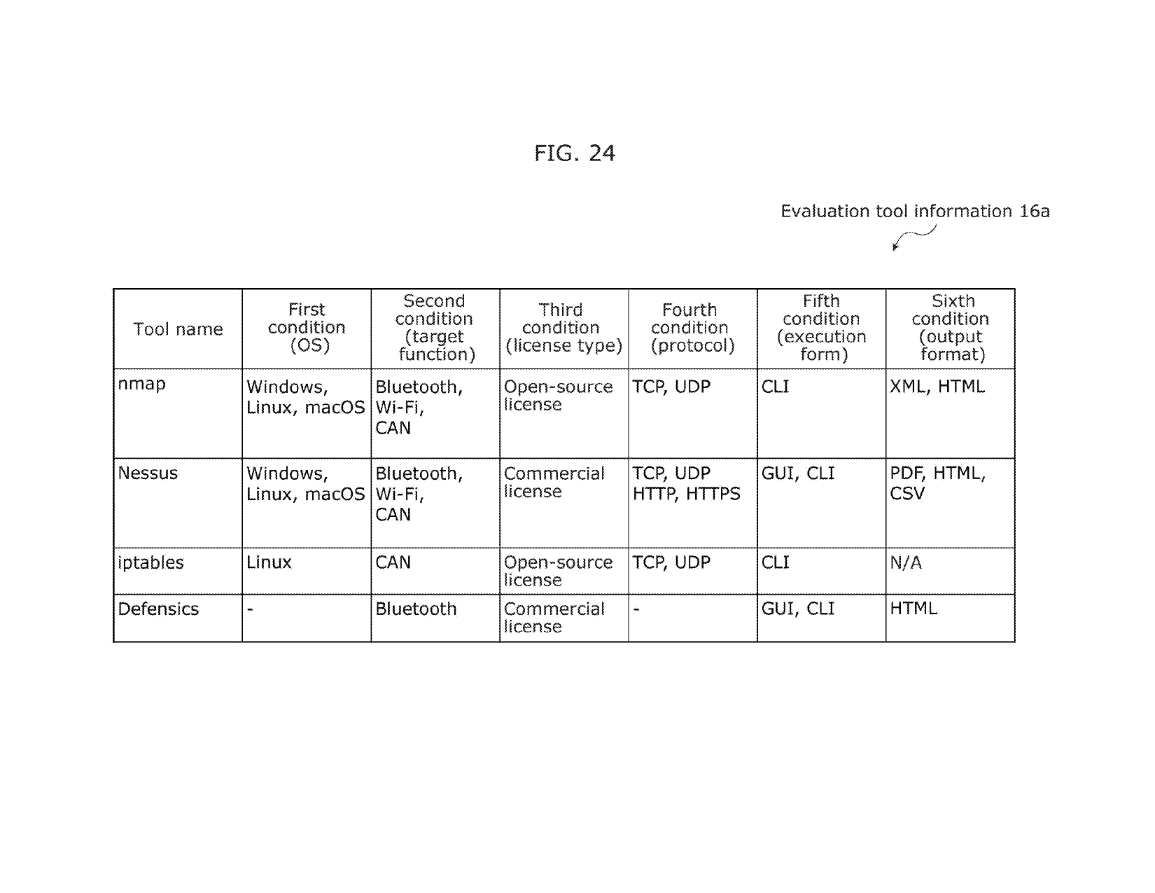

In a specific example, evaluation tool information 16a indicates the tool name "tn1," the first condition "f1," the second condition "a1," the third condition "L1," the fourth condition "P1," the fifth condition "Ex1," and the sixth condition "Ut1" in association with one another. Note that a more specific example of evaluation tool information 16a is as shown in FIG. 24.

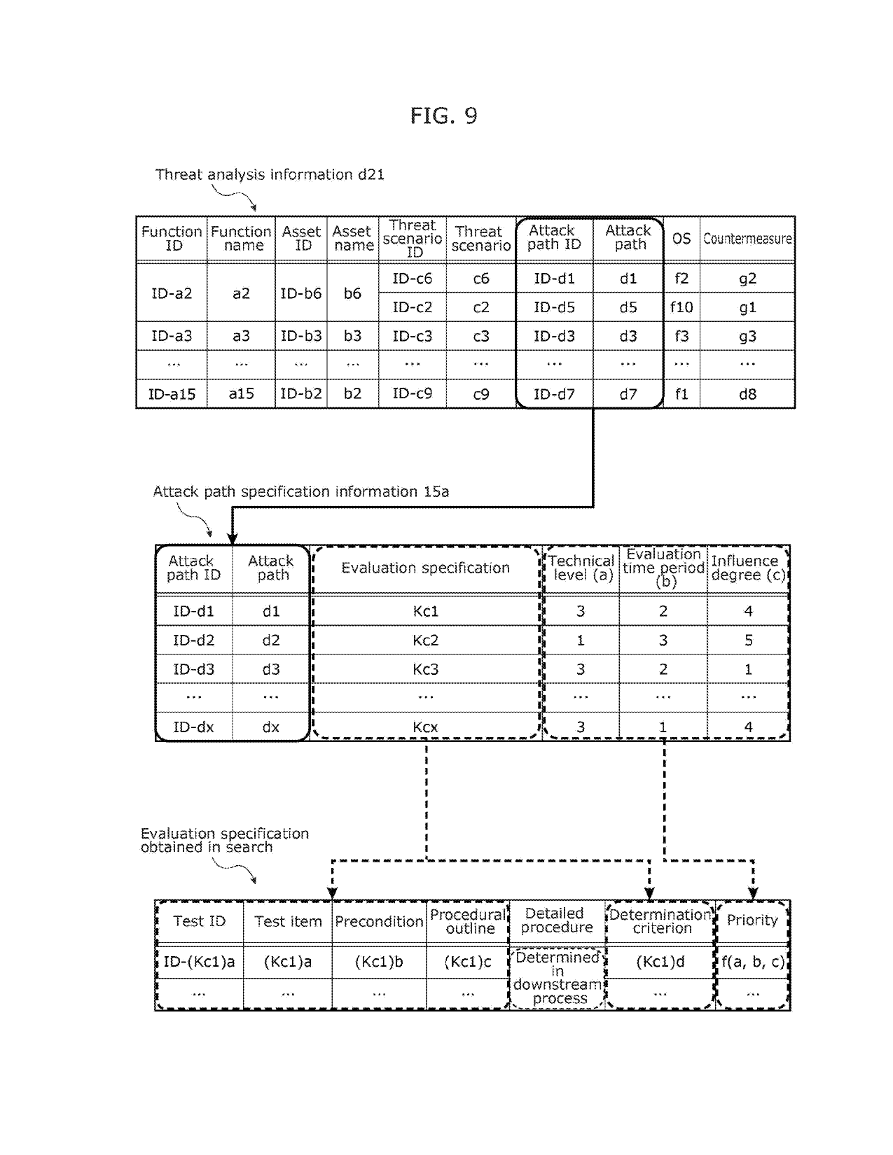

FIG. 9 is a diagram for describing an example of a process in which evaluation specification generator 12 searches attack path specification information 15a for an evaluation specification.

Evaluation specification generator 12 first searches, for each set of an attack path ID and an attack path indicated by threat analysis information d21, attack path specification information 15a for an evaluation specification associated with the set. Evaluation specification generator 12 then adds a detailed procedure and a priority to the evaluation specification obtained in the searching.

That is, evaluation specification generator 12 generates the procedure for evaluation of evaluation target device 40, which is a detailed procedure indicating the procedural outline included in the evaluation specification in detail, and adds the generated detailed procedure to the evaluation specification obtained in the searching. Evaluation specification generator 12 determines the priority of the evaluation specification obtained in the searching. In this determination, evaluation specification generator 12 identifies a technical level, an evaluation time period, and an influence degree that are associated with the set described above in attack path specification information 15a. Evaluation specification generator 12 then determines the priority by performing weighted addition of the identified technical level, evaluation time period, and influence degree. For example, the technical level, the evaluation time period, and the influence degree are represented by variable a, variable b, and variable c, respectively. In this case, evaluation specification generator 12 determines the priority by calculating f(a, b, c) = (p × a) + (q × b) + (r × c), which is the function of the weighted addition. Note that p, q, and r are weights satisfying p + q + r = 1.

Specifically, evaluation specification generator 12 obtains the evaluation specification "Kc1," which is associated with the set of the attack path ID "ID-d1" and the attack path "d1" indicated in threat analysis information d21, by searching attack path specification information 15a. The evaluation specification "Kc1" includes the test ID "ID-(Kc1)a," the test item "(Kc1)a," the precondition "(Kc1)b," the procedural outline "(Kc1)c," and the determination criterion "(Kc1)d." Evaluation specification generator 12 adds, to the evaluation specification "Kc1," the detailed procedure indicating the procedural outline "(Kc1)c" in detail and the priority of the evaluation specification corresponding to the test ID "ID-(Kc1)a."

Evaluation specification generator 12 adds the detailed procedure to the evaluation specification by adding first the detailed procedure to the evaluation specification as a blank item and, in a downstream process described later, inserting the content of the detailed procedure into the blank item.

Evaluation specification generator 12 adds the priority to the evaluation specification by performing the weighted addition described above on the technical level "3," the evaluation time period "2," and the influence degree "4," which are associated with the set of the attack path ID "ID-d1" and the attack path "d1" indicated in threat analysis information d21. That is, in f(a, b, c), which is the function of the weighted addition, evaluation specification generator 12 replaces variable a with "3," variable b with "2," and variable c with "4," thus performing the calculation of (p × 3) + (q × 2) + (r × 4). Evaluation specification generator 12 thus determines the priority of the evaluation specification corresponding to the test ID "ID-(Kc1)a."

Here, weights p, q, and r are set based on the balance among quality, cost, and delivery (QCD). For example, in a case where the evaluating person intends to determine the priority mainly from the viewpoints of quality or influence degree, weight r for influence degree is set to have a value larger than that of weight p for technical level and that of weight q for evaluation time period. In a case where the evaluating person intends to determine the priority mainly from the viewpoint of evaluation time period, weight q for evaluation time period is set to have a value larger than that of weight p for technical level and that of weight r for influence degree. In a case where the evaluating person intends to determine the priority mainly from the viewpoint of technical level, weight p for technical level is set to have a value larger than that of weight q for evaluation time period and that of weight r for influence degree. This makes it possible to determine the priorities of evaluation specifications appropriately, thus facilitating scheduling the order of performing evaluations according to the evaluation specifications.

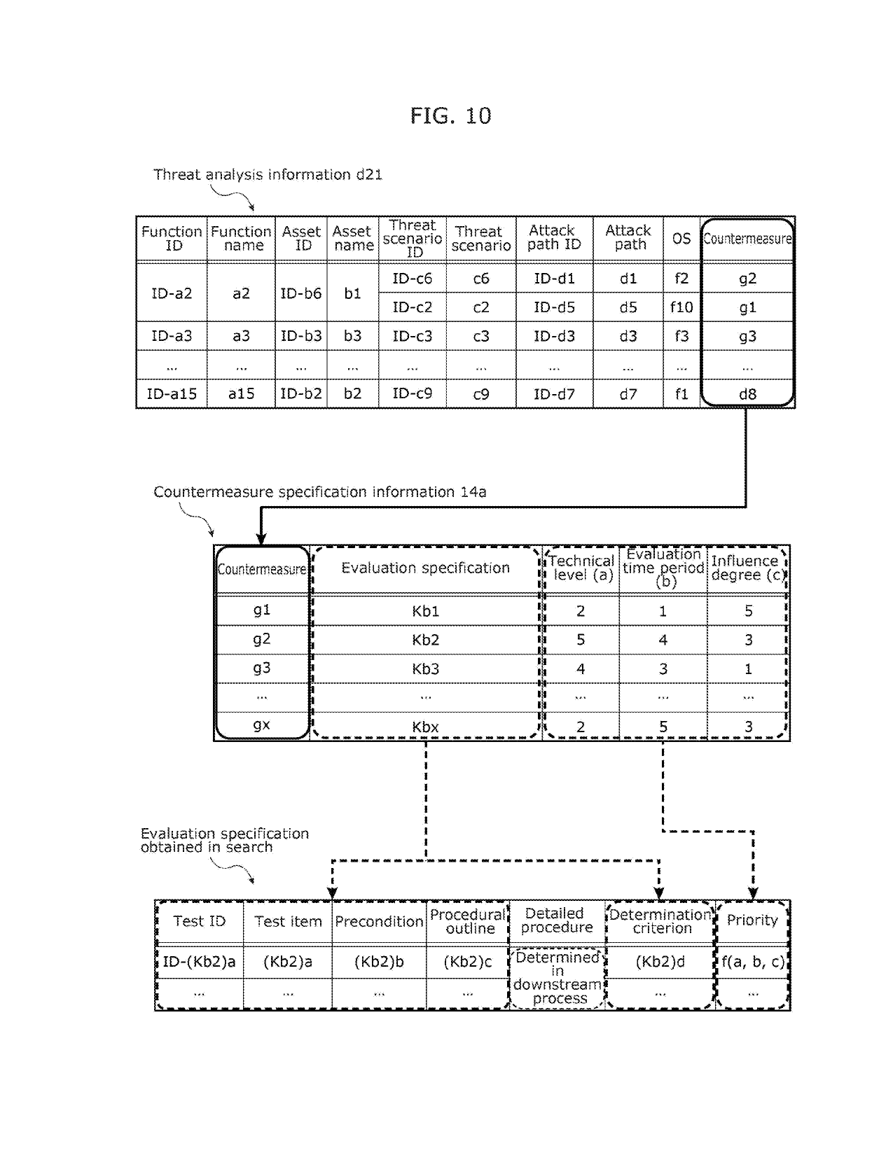

FIG. 10 is a diagram for describing an example of a process in which evaluation specification generator 12 searches countermeasure specification information 14a for an evaluation specification.

Evaluation specification generator 12 first searches, for each countermeasure indicated in threat analysis information d21, countermeasure specification information 14a for an evaluation specification associated with the countermeasure. Evaluation specification generator 12 then adds a detailed procedure and a priority to the evaluation specification obtained in the searching.

That is, evaluation specification generator 12 generates the procedure for evaluation of evaluation target device 40, which is a detailed procedure indicating the procedural outline included in the evaluation specification in detail, and adds the generated detailed procedure to the evaluation specification obtained in the searching. Evaluation specification generator 12 determines the priority of the evaluation specification obtained in the searching. In this determination, evaluation specification generator 12 identifies a technical level, an evaluation time period, and an influence degree that are associated with the countermeasure described above in countermeasure specification information 14a. Evaluation specification generator 12 then determines the priority by performing weighted addition of the identified technical level, evaluation time period, and influence degree. The function f(a, b, c) of the weighted addition is as described above.

Specifically, evaluation specification generator 12 obtains the evaluation specification "Kb2," which is associated with the countermeasure "g2" indicated in threat analysis information d21, by searching countermeasure specification information 14a. The evaluation specification "Kb2" includes the test ID "ID-(Kb2)a," the test item "(Kb2)a," the precondition "(Kb2)b," the procedural outline "(Kb2)c," and the determination criterion "(Kb2)d." Evaluation specification generator 12 adds, to the evaluation specification "Kb2," the detailed procedure indicating the procedural outline "(Kb2)c" in detail and the priority of the evaluation specification corresponding to the test ID "ID-(Kb2)a."

Evaluation specification generator 12 adds the detailed procedure to the evaluation specification by adding first the detailed procedure to the evaluation specification as a blank item and, in a downstream process described later, inserting the content of the detailed procedure into the blank item.

Evaluation specification generator 12 adds the priority to the evaluation specification by performing the weighted addition described above on the technical level "5," the evaluation time period "4," and the influence degree "3," which are associated with the countermeasure "g2" indicated in threat analysis information d21. That is, in f(a, b, c), which is the function of the weighted addition, evaluation specification generator 12 replaces variable a with "5," variable b with "4," and variable c with "3," thus performing the calculation of (p × 5) + (q × 4) + (r × 3). Evaluation specification generator 12 thus determines the priority of the evaluation specification corresponding to the test ID "ID-(Kb2)a."

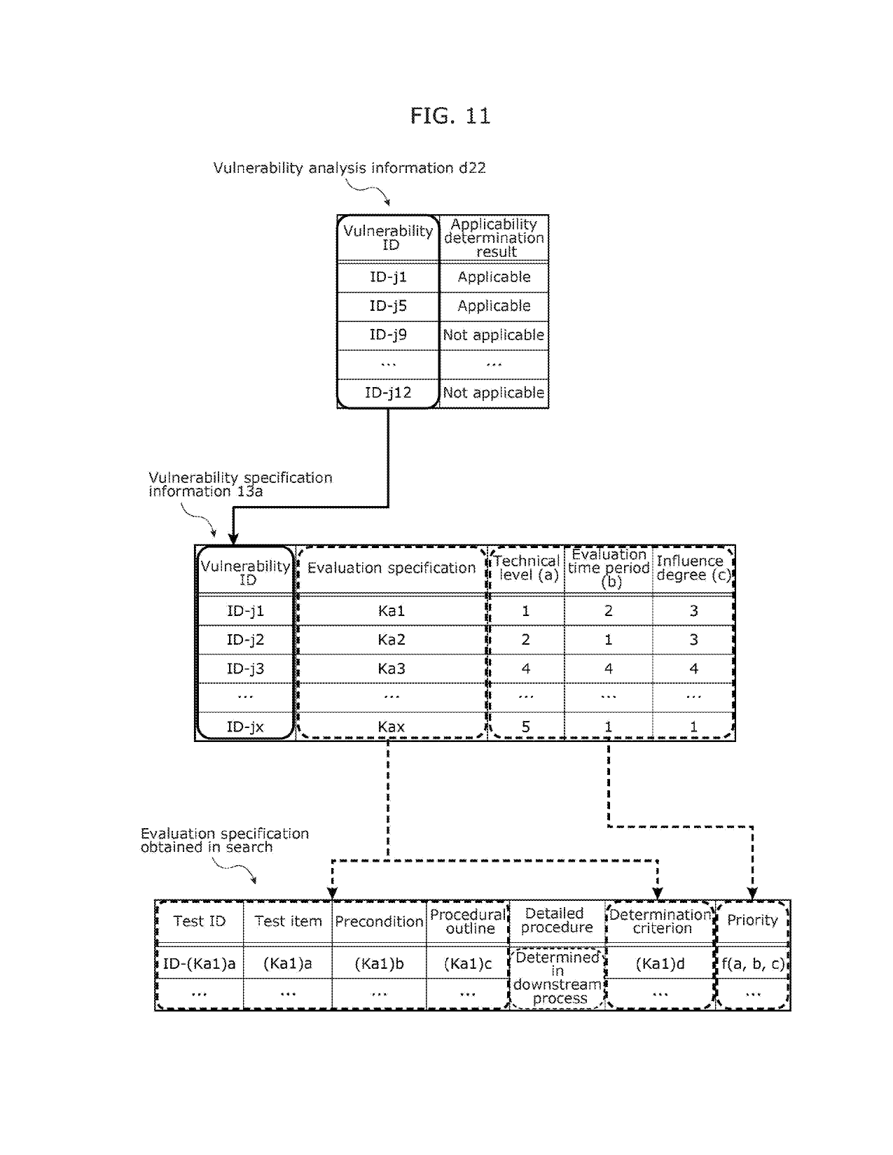

FIG. 11 is a diagram for describing an example of a process in which evaluation specification generator 12 searches vulnerability specification information 13a for an evaluation specification.

Evaluation specification generator 12 first searches, for each vulnerability ID associated with the determination result "applicable" in vulnerability analysis information d22, vulnerability specification information 13a for an evaluation specification associated with the vulnerability ID. Evaluation specification generator 12 then adds a detailed procedure and a priority to the evaluation specification obtained in the searching.

That is, evaluation specification generator 12 generates the procedure for evaluation of evaluation target device 40, which is a detailed procedure indicating the procedural outline included in the evaluation specification in detail, and adds the generated detailed procedure to the evaluation specification obtained in the searching. Evaluation specification generator 12 determines the priority of the evaluation specification obtained in the searching. In this determination, evaluation specification generator 12 identifies a technical level, an evaluation time period, and an influence degree that are associated with the vulnerability ID described above in vulnerability specification information 13a. Evaluation specification generator 12 then determines the priority by performing weighted addition of the identified technical level, evaluation time period, and influence degree. The function f(a, b, c) of the weighted addition is as described above.

Specifically, evaluation specification generator 12 identifies the vulnerability ID "ID-j1," which is associated with the determination result "applicable," in vulnerability analysis information d22. Evaluation specification generator 12 then obtains the evaluation specification "Ka1," which is associated with the vulnerability ID "ID-j1," by searching vulnerability specification information 13a. The evaluation specification "Ka1" includes the test ID "ID-(Ka1)a," the test item "(Ka1)a," the precondition "(Ka1)b," the procedural outline "(Ka1)c," and the determination criterion "(Ka1)d." Evaluation specification generator 12 adds, to the evaluation specification "Ka1," the detailed procedure indicating the procedural outline "(Ka1)c" in detail and the priority of the evaluation specification corresponding to the test ID "ID-(Ka1)a."

Evaluation specification generator 12 adds the detailed procedure to the evaluation specification by adding first the detailed procedure to the evaluation specification as a blank item and, in a downstream process described later, inserting the content of the detailed procedure into the blank item.

Evaluation specification generator 12 adds the priority to the evaluation specification by performing the weighted addition described above on the technical level "1," the evaluation time period "2," and the influence degree "3," which are associated with the vulnerability ID "ID-j1." Note that the vulnerability ID "ID-j1" is a vulnerability ID that is associated with the determination result "applicable" in vulnerability analysis information d22. That is, in f(a, b, c), which is the function of the weighted addition, evaluation specification generator 12 replaces variable a with "1," variable b with "2," and variable c with "3," thus performing the calculation of (p × 1) + (q × 2) + (r × 3). Evaluation specification generator 12 thus determines the priority of the evaluation specification corresponding to the test ID "ID-(Ka1)a."

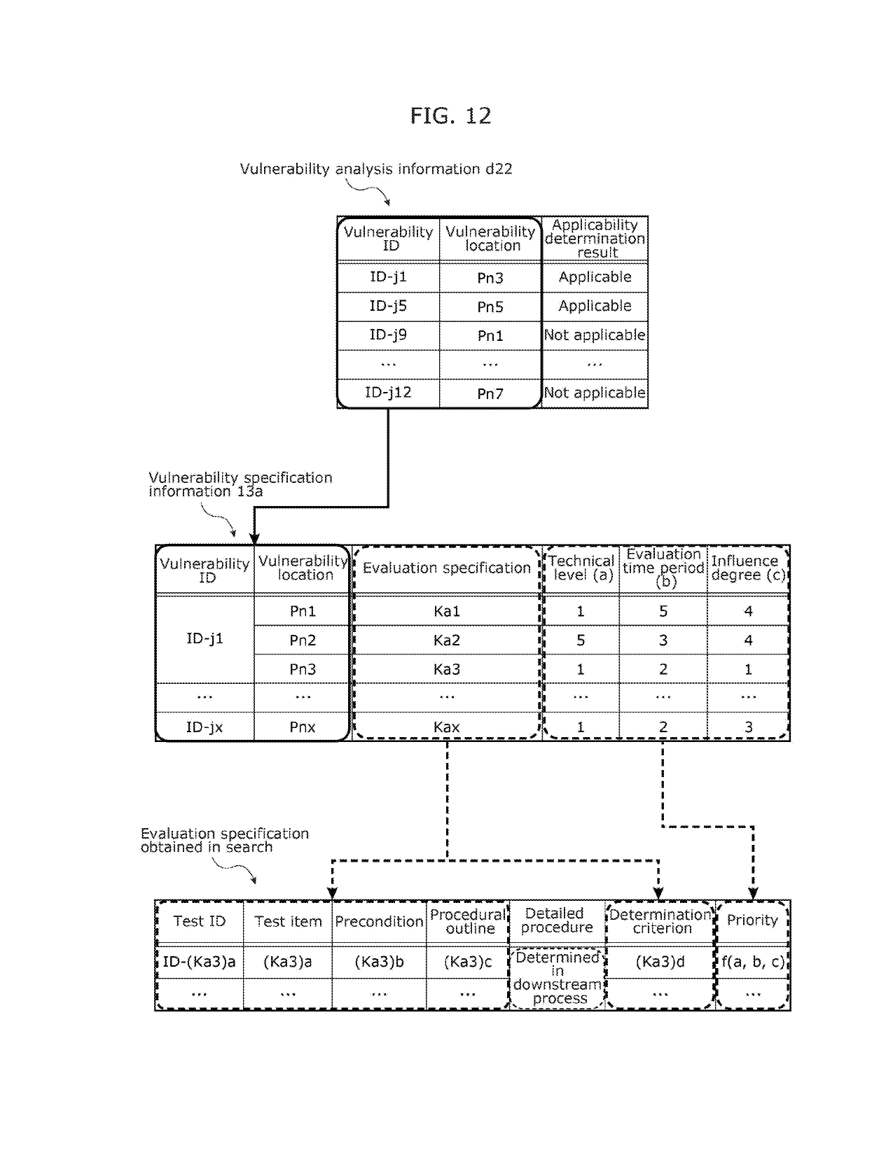

FIG. 12 is a diagram for describing another example of a process in which evaluation specification generator 12 searches vulnerability specification information 13a for an evaluation specification.

As illustrated in FIG. 12, vulnerability analysis information d22 may further indicate, for each vulnerability ID, a vulnerability location where the vulnerability identified with the vulnerability ID is located. The vulnerability location may be, for example, either Main microcomputer 44 or BT interface 41 illustrated in FIG. 2. In this case, vulnerability specification information 13a indicates, for each set of a vulnerability ID and a vulnerability location, the set, the evaluation specification for the vulnerability ID of the set, and the technical level, evaluation time period, and influence degree of the evaluation specification in association with one another.

Evaluation specification generator 12 then searches, for each set of a vulnerability ID and a vulnerability location associated with the determination result "applicable" in vulnerability analysis information d22, vulnerability specification information 13a for an evaluation specification associated with the set. Evaluation specification generator 12 then adds a detailed procedure and a priority to the evaluation specification obtained in the searching, as described above.

Specifically, evaluation specification generator 12 identifies the set of the vulnerability ID "ID-j1" and the vulnerability location "Pn3," which are associated with the determination result "applicable," in vulnerability analysis information d22. Evaluation specification generator 12 then obtains the evaluation specification "Ka3," which is associated with the set," by searching vulnerability specification information 13a. The evaluation specification "Ka3" includes the test ID "ID-(Ka3)a," the test item "(Ka3)a," the precondition "(Ka3)b," the procedural outline "(Ka3)c," and the determination criterion "(Ka3)d." Evaluation specification generator 12 adds, to the evaluation specification "Ka3," the detailed procedure indicating the procedural outline "(Ka3)c" in detail and the priority of the evaluation specification corresponding to the test ID "ID-(Ka3)a."

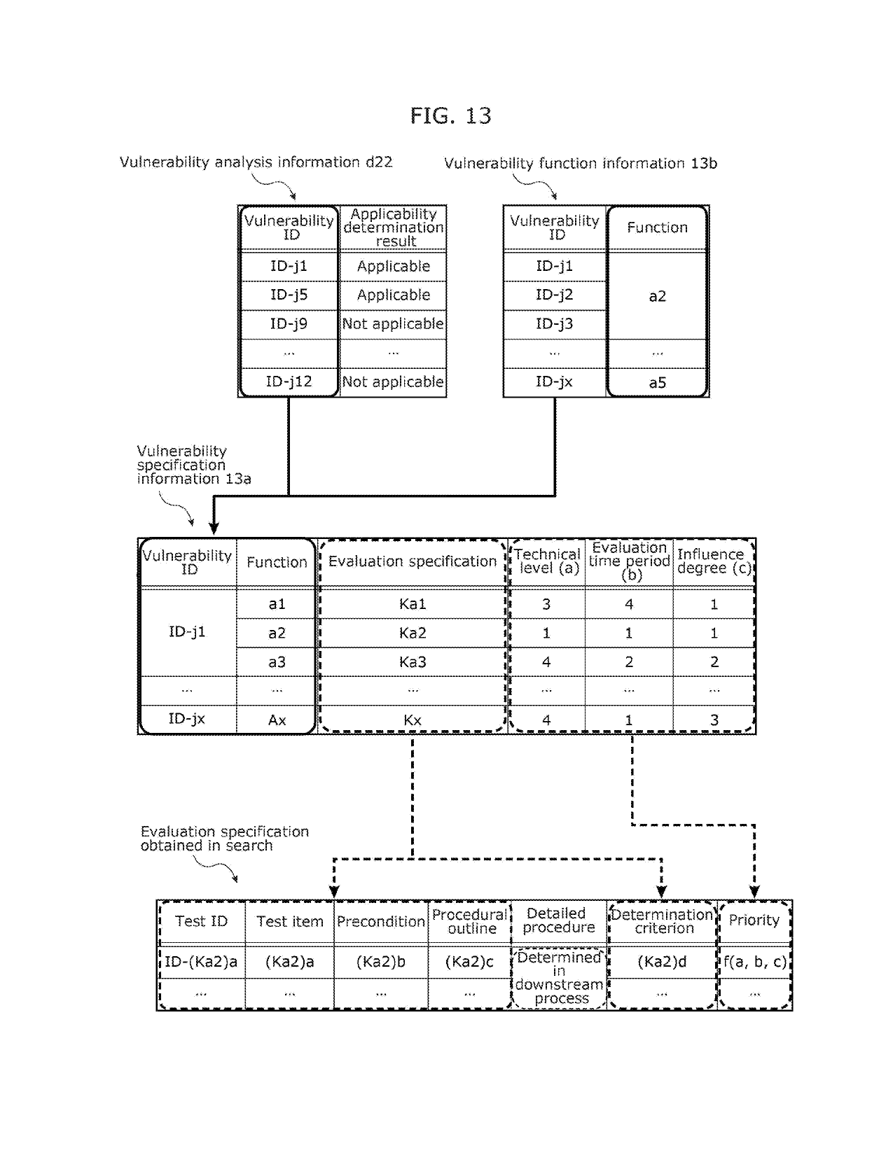

FIG. 13 is a diagram for describing still another example of a process in which evaluation specification generator 12 searches vulnerability specification information 13a for an evaluation specification.

As illustrated in FIG. 13, vulnerability specification database 13 may store, for each vulnerability ID, vulnerability function information 13b indicating a function relating to the vulnerability identified with the vulnerability ID. In this case, vulnerability specification information 13a indicates, for each set of a vulnerability ID and a function, the set, the evaluation specification for the vulnerability ID of the set, and the technical level, evaluation time period, and influence degree of the evaluation specification in association with one another.

Evaluation specification generator 12 then identifies sets each including a vulnerability ID associated with the determination result "applicable" in vulnerability analysis information d22 and the function associated with the vulnerability ID in vulnerability function information 13b. Evaluation specification generator 12 further searches, for each of the sets, vulnerability specification information 13a for an evaluation specification associated with the set. Evaluation specification generator 12 then adds a detailed procedure and a priority to the evaluation specification obtained in the searching, as described above. That is, in the example illustrated in FIG. 13, an evaluation specification, a technical level, an evaluation time period, and an influence degree corresponding to a vulnerability ID associated with the determination result "applicable" in vulnerability analysis information d22 are narrowed down with a function.

Specifically, evaluation specification generator 12 identifies the set including the vulnerability ID "ID-j1," which is associated with the determination result "applicable" in vulnerability analysis information d22 and the function "a2," which is associated with the vulnerability ID "ID-j1" in vulnerability function information 13b. Evaluation specification generator 12 then obtains the evaluation specification "Ka2," which is associated with the set," by searching vulnerability specification information 13a. The evaluation specification "Ka2" includes the test ID "ID-(Ka2)a," the test item "(Ka2)a," the precondition "(Ka2)b," the procedural outline "(Ka2)c," and the determination criterion "(Ka2)d." Evaluation specification generator 12 adds, to the evaluation specification "Ka2," the detailed procedure indicating the procedural outline "(Ka2)c" in detail and the priority of the evaluation specification corresponding to the test ID "ID-(Ka2)a."

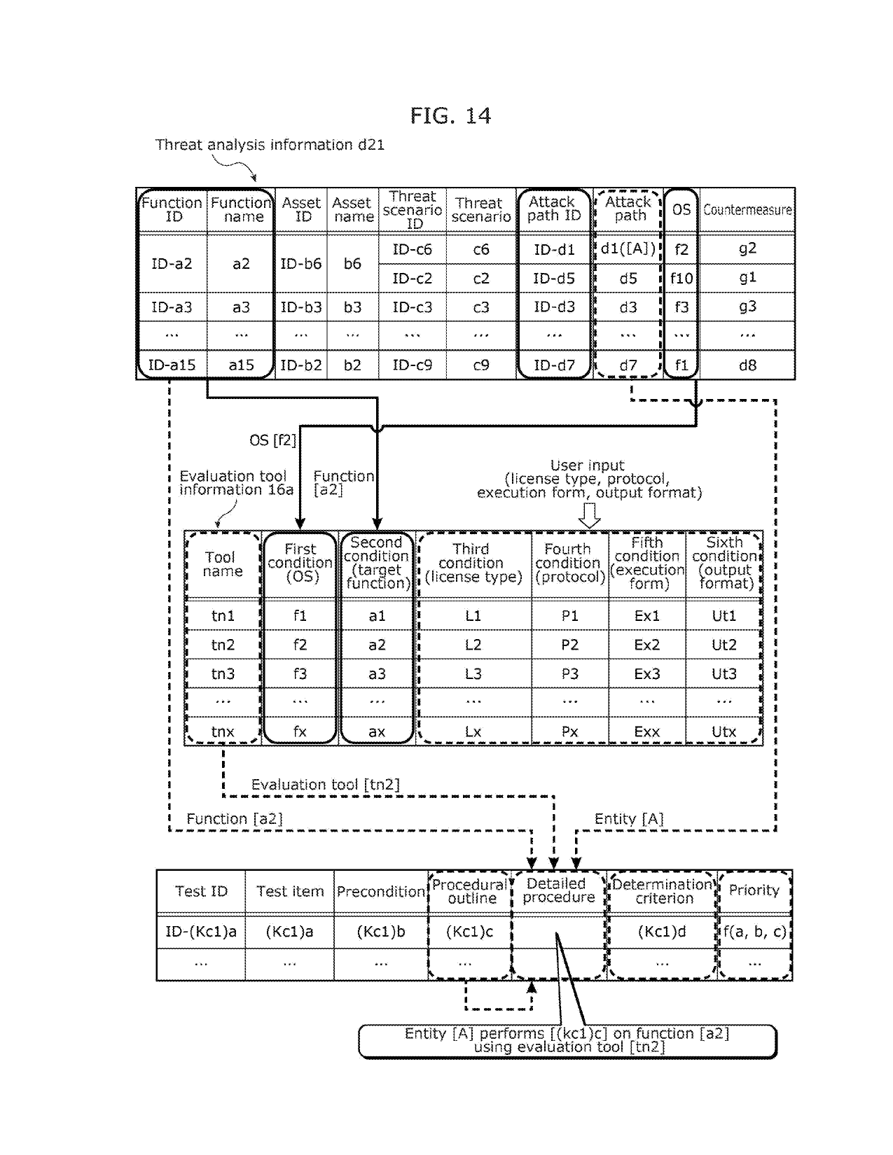

FIG. 14 is a diagram for describing an example of a process in which evaluation specification generator 12 generates a detailed procedure. That is, FIG. 14 is a diagram for describing the downstream process described above.

Evaluation specification generator 12 generates a detailed procedure to be included in the evaluation specification obtained in the search as described above. That is, evaluation specification generator 12 generates the content of the detailed procedure that has been set as a blank item in the evaluation specification. In this generation, evaluation specification generator 12 identifies a function ID, a function name, an attack path, and an OS corresponding to the evaluation specification.

For example, in a case where the evaluation specification has been obtained as a result of the search in threat analysis information d21 as illustrated in FIG. 9 and FIG. 10, evaluation specification generator 12 identifies, from threat analysis information d21, an attack path that is used in the search of the evaluation specification, and an OS, a function ID, and a function name that are associated with an attack path or a countermeasure used in the search of the evaluation specification.

Evaluation specification generator 12 further obtains a license type, a protocol, an execution form, and an output format of the function with the function ID and the function name in response to, for example, an input operation by a user (i.e., a user input). Examples of the license type include an open-source license or a commercial license. Examples of the protocol include TCP, user datagram protocol (UDP), and hypertext transfer protocol (HTTP). Examples of the execution form include GUI and command line interface (CLI). Examples of the output format include XML and hypertext markup language (HTML). Note that the OS, the function with the function ID and the function name, the license type, the protocol, the execution form, and the output format described above are each also referred to as an evaluation environment element.

Evaluation specification generator 12 next identifies, from evaluation tool information 16a, a tool name that corresponds to the identified OS, function ID, and function name described above, and to the obtained license type, protocol, execution form, and output format described above. That is, evaluation specification generator 12 identifies a tool name the first condition of which is satisfied by the identified OS described above, the second condition of which is satisfied by the function with the identified function ID and function name described above, and the third condition, fourth condition, fifth condition, and sixth condition of which are satisfied by the obtained license type, protocol, execution form, and output format described above, respectively, from evaluation tool information 16a. For example, in a case where the identified OS described above is indicated as the first condition, the OS satisfies the first condition. Likewise, in a case where the function with the identified function ID and function name described above is indicated as the second condition, the function satisfies the second condition. Likewise, in a case where the four obtained evaluation environment elements: license type, protocol, execution form, and output format are indicated as the third condition, the fourth condition, the fifth condition, and the sixth condition, respectively, the four evaluation environment elements satisfy the third condition, the fourth condition, the fifth condition, and the sixth condition.

As a result, evaluation specification generator 12 determines the evaluation tool with the identified tool name, as a tool to be used in the evaluation specification obtained as a result of the search described above. Evaluation specification generator 12 further determines the function with the function ID and function name identified as described above as a location where an evaluation is to be performed according to the evaluation specification. Evaluation specification generator 12 further determines an entity included in the identified attack path described above as an entity that is to perform the evaluation according to the evaluation specification. Note that the entity is an entity that is to follow the attack path to make an attack. Evaluation specification generator 12 further determines a procedural outline according to which the evaluation is performed according to the evaluation specification. Evaluation specification generator 12 thus generates, as a detailed procedure, the execution of the determined procedural outline by the determined entity described above on the determined function described above using the determined evaluation tool described above.

Specifically, as illustrated in FIG. 9, threat analysis information d21 is used to search for an evaluation specification corresponding to the test ID "ID-(Kc1)a." In this case, from threat analysis information d21, evaluation specification generator 12 identifies the attack path "d1" used in the search of the evaluation specification, the OS "f2," the function ID "ID-a2," and the function name "a2" that are associated with the attack path.

Evaluation specification generator 12 further obtains the license type "L2," the protocol "P2," the execution form "Ex2," and the output format "Ut2" of the function with the function ID "ID-a2" and the function name "a2" in response to, for example, an input operation by the user.

Evaluation specification generator 12 next identifies, from evaluation tool information 16a, the tool name "tn2," which corresponds to the identified OS "f2," the function ID "ID-a2," and the function name "a2" described above, and to the obtained license type "L2," the protocol "P2," the execution form "Ex2," and the output format "Ut2" described above. That is, evaluation specification generator 12 identifies the tool name "tn2" which is associated with the first condition indicating the identified OS "f2" described above, the second condition indicating the function with the identified function ID "ID-a2" and the function name "a2" described above (i.e., the function "a2"), and the third condition, the fourth condition, the fifth condition, and the sixth condition indicating the obtained license type "L2," the protocol "P2," the execution form "Ex2," and the output format "Ut2" described above, respectively, from evaluation tool information 16a.

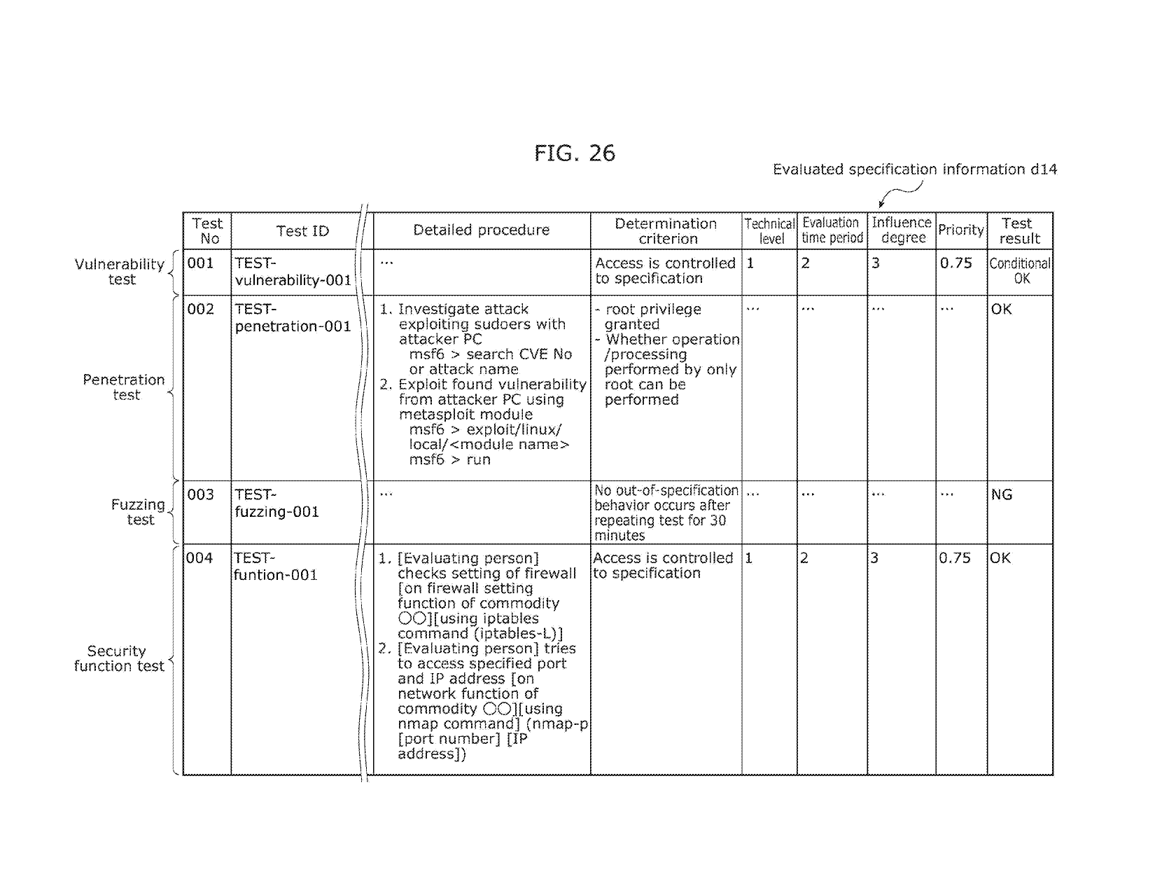

As a result, evaluation specification generator 12 determines the evaluation tool with the identified tool name "tn2," as a tool to be used in the evaluation specification obtained (i.e., the evaluation tool "tn2") as a result of the search described above. Evaluation specification generator 12 further determines the function with the function ID "ID-a2" and the function name "a2" identified as described above (i.e., the function [a2]) as a location where an evaluation is to be performed according to the evaluation specification. Evaluation specification generator 12 further determines, as the entity that is to perform the evaluation according to the evaluation specification, the entity "A" included in the identified attack path "d1" described above. Evaluation specification generator 12 further determines the procedural outline "(Kc1)c" according to which the evaluation is performed according to the evaluation specification. Evaluation specification generator 12 thus generates, as a detailed procedure, the execution of the procedural outline "(Kc1)c" by the entity "A" on the function "a2" using the evaluation tool "tn2." Note that a more specific example of the detailed procedure is as shown in FIG. 26.

Note that, in a case where the evaluation specification is obtained as a result of the search in vulnerability analysis information d22 as illustrated in FIG. 13, evaluation specification generator 12 may identify a function associated with a vulnerability ID corresponding to the evaluation specification from vulnerability function information 13b. Evaluation specification generator 12 may then identify, from threat analysis information d21, the function ID and function name of the identified function, and an attack path and an OS that are associated with the function ID and the function name. Evaluation specification generator 12 may then generate a detailed procedure to be included in the evaluation specification as in the example illustrated in FIG. 14. Although FIG. 14 illustrates the example in which the function ID and the function name in threat analysis information d21 are used to generate the detailed procedure, an asset ID and an asset name may be used. In this case, evaluation tool information 16a may indicate a target asset (i.e., the asset name) as the second condition.

For each evaluation specification obtained in the search as described above, evaluation specification generator 12 adds a detailed procedure and a priority to the evaluation specification. Evaluation specification generator 12 then merges a plurality of evaluation specifications each including a detailed procedure and a priority to generate evaluation specification information d13 and outputs evaluation specification information d13.

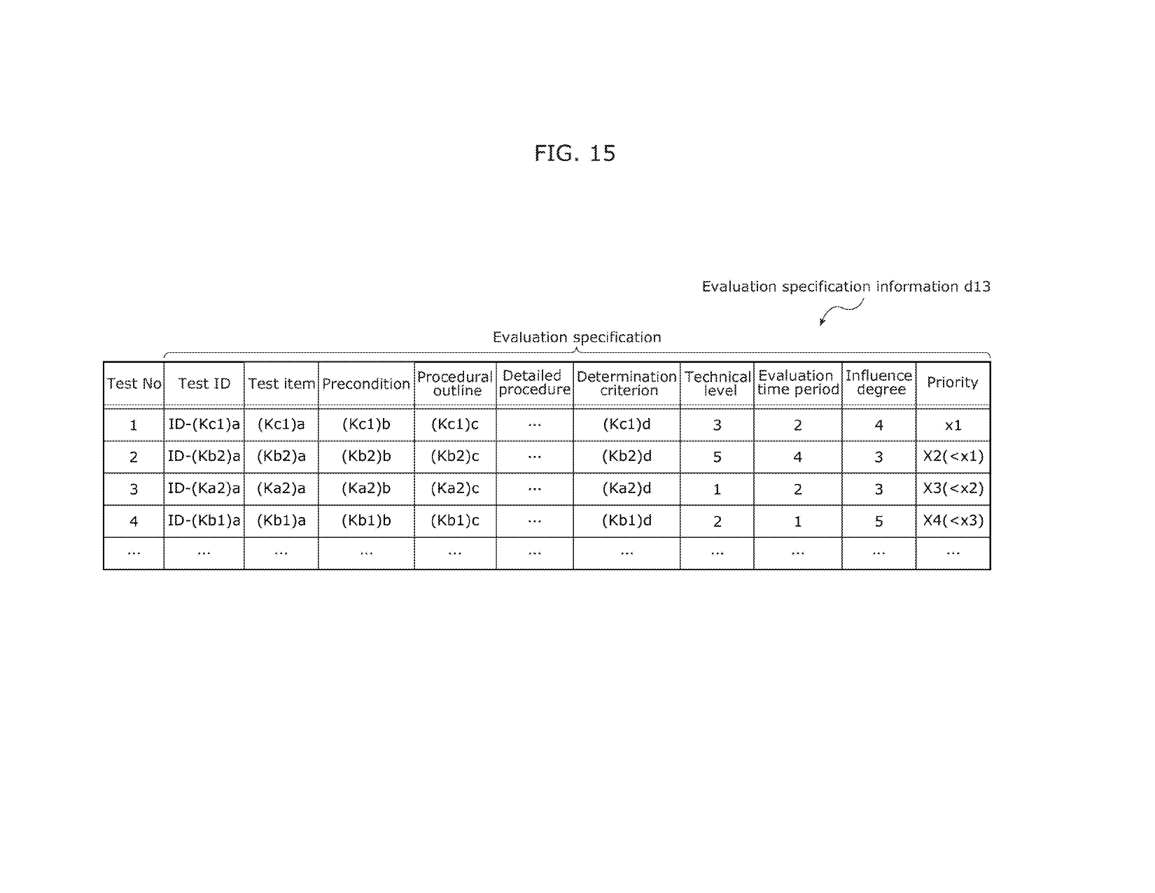

FIG. 15 is a table showing a schematic example of evaluation specification information d13 that is generated and output by evaluation specification generator 12.

As shown in FIG. 15, evaluation specification information d13 includes a plurality of evaluation specifications each of which is assigned a test number (i.e., a test No). Each of the plurality of evaluation specifications includes a test ID, a test item, a precondition, a procedural outline, a detailed procedure, a determination criterion, a technical level, an evaluation time period, an influence degree, and a priority. Note that, in the example shown in FIG. 15, evaluation specification generator 12 obtains the technical level, the evaluation time period, and the influence degree from attack path specification information 15a, countermeasure specification information 14a, or vulnerability specification information 13a and adds them to the evaluation specification. However, the technical level, the evaluation time period, and the influence degree need not be added to the evaluation specification.

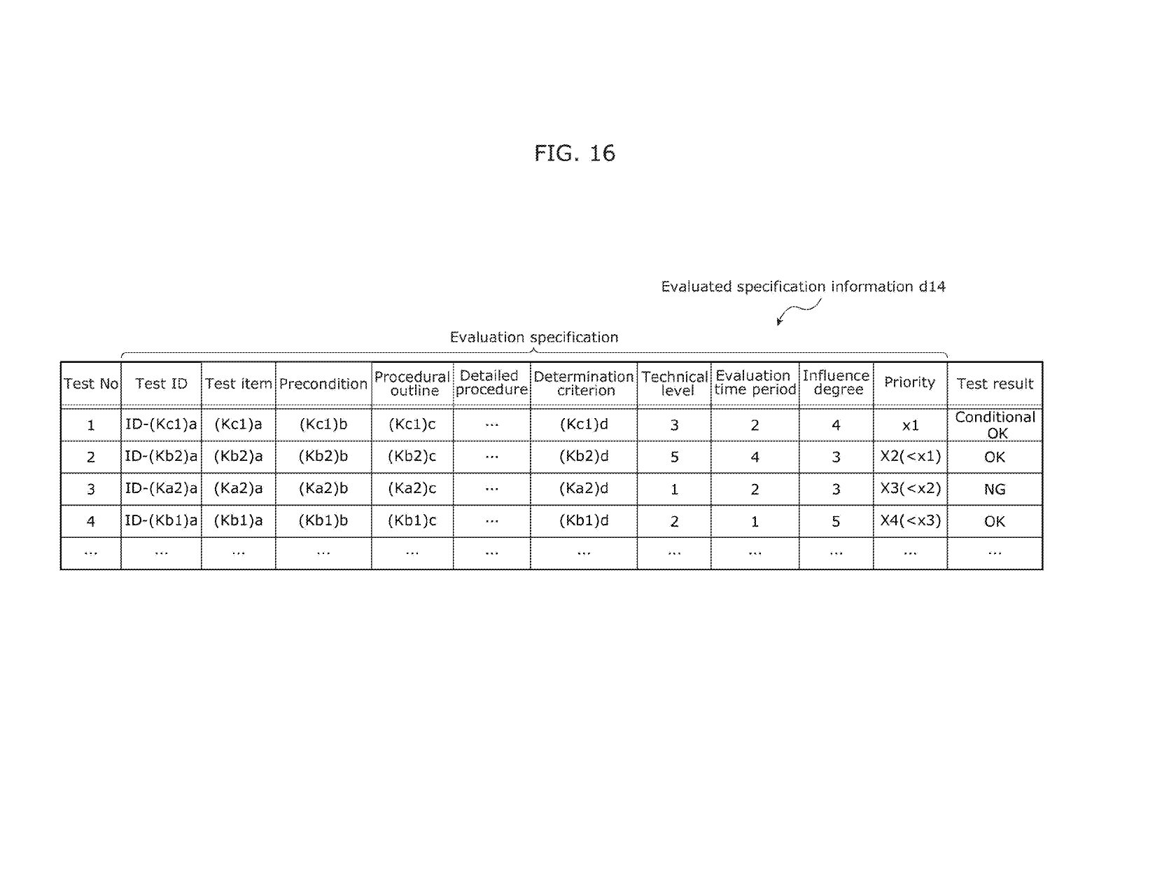

FIG. 16 is a table showing a schematic example of evaluated specification information d14 that is provided from evaluation database 17 to threat analyzer 21 and vulnerability analyzer 22 as feedback.

Evaluated specification information d14 includes evaluation specification information d13 and determination information d33, which is constituted of a plurality of test results. Each of the plurality of test results indicates OK or NG as an evaluation result of evaluating evaluation target device 40 according to the corresponding evaluation specification indicated in evaluation specification information d13. The test result may indicate conditional OK as an evaluation result. The conditional OK indicates that the evaluation result is considered to be OK if a predetermined condition is satisfied. Alternatively, the conditional OK indicates that the evaluation result is good in terms of the specifications while problematic in terms of security. The test result may also indicate that the evaluation result is NT. NT indicates that no evaluation can be performed according to the evaluation specification due to no corresponding function or the like, that is, the corresponding test item is excluded from the test.

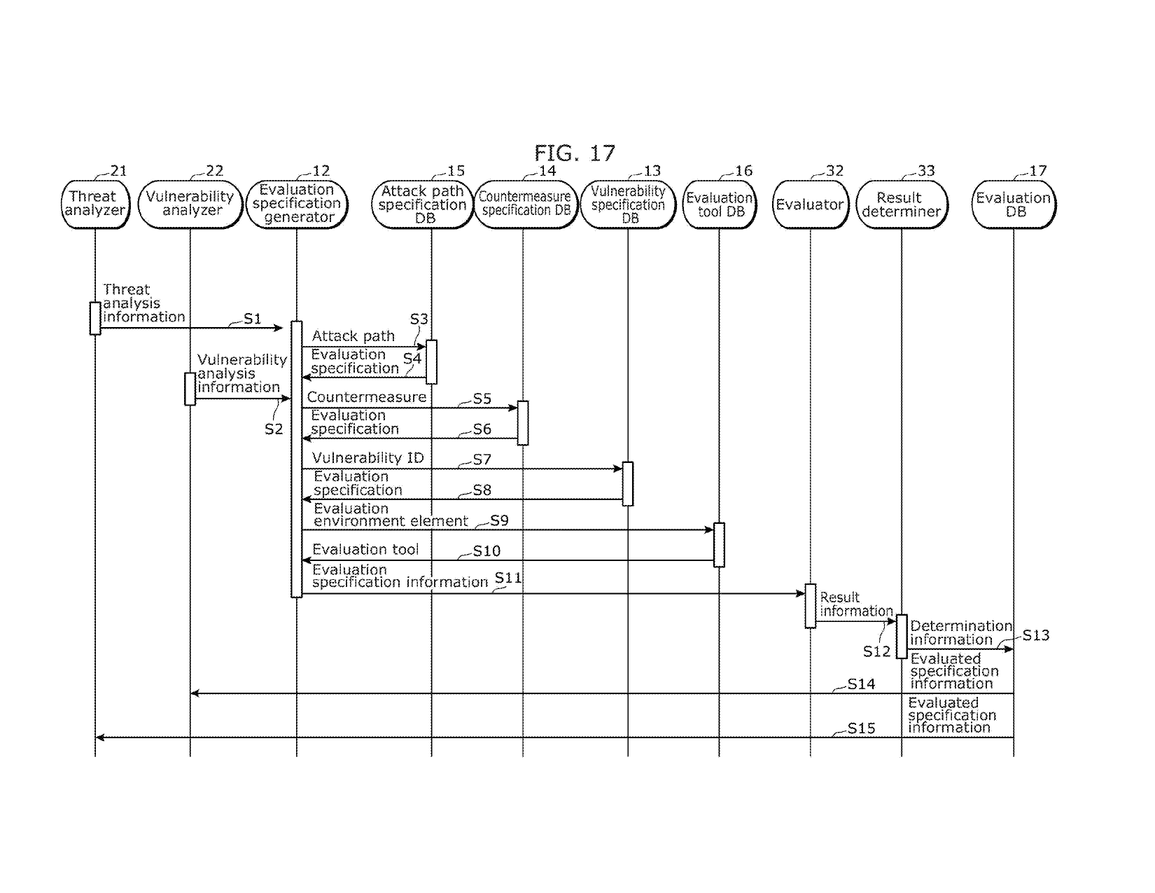

FIG. 17 is a sequence diagram illustrating an example of a processing operation of development system 100.

Threat analyzer 21 generates threat analysis information d21 and outputs threat analysis information d21 to evaluation specification generator 12 via obtainer 11 (step S1). Vulnerability analyzer 22 generates vulnerability analysis information d22 and outputs vulnerability analysis information d22 to evaluation specification generator 12 via obtainer 11 (step S2).

Evaluation specification generator 12 transmits the set of an attack path ID and an attack path included in threat analysis information d21 to attack path specification database 15 (step S3). Evaluation specification generator 12 then obtains an evaluation specification associated with the set from attack path specification database 15 (step S4).

Evaluation specification generator 12 next transmits a countermeasure included in threat analysis information d21 to countermeasure specification database 14 (step S5). Evaluation specification generator 12 then obtains an evaluation specification associated with the countermeasure from countermeasure specification database 14 (step S6).

Evaluation specification generator 12 next transmits a vulnerability ID included in vulnerability analysis information d22 to vulnerability specification database 13 (step S7). Evaluation specification generator 12 then obtains an evaluation specification associated with the vulnerability ID from vulnerability specification database 13 (step S8).

Evaluation specification generator 12 next transmits information indicating a plurality of evaluation environment elements to evaluation tool database 16 (step S9). Evaluation specification generator 12 then obtains a tool name associated with the information from evaluation tool database 16 (step S10). That is, evaluation specification generator 12 identifies the evaluation tool with the tool name. Note that the plurality of evaluation environment elements each include the OS, the function with the function ID and the function name, the license type, the protocol, the execution form, and the output format described above.

In steps S3 to S10, evaluation specification generator 12 transmits a plurality of information items including an attack path and a countermeasure to a plurality of databases and obtains a plurality of evaluation specifications and a tool name from the databases. However, evaluation specification generator 12 may obtain the evaluation specification or the tool name from information included in each database in searching.

Then, based on the obtained plurality of evaluation specifications and tool name, evaluation specification generator 12 generates evaluation specification information d13 and outputs evaluation specification information d13 to evaluator 32 (step S11). Evaluator 32 evaluates evaluation target device 40 according to evaluation specification information d13, generates result information d32 indicating the result of the evaluation, and outputs result information d32 to result determiner 33 (step S12). Result determiner 33 determines, based on a determination criterion included in evaluation specification information d13, whether the result of the evaluation indicated in result information d32 is OK or NG, and stores determination information d33 indicating the result of the determination in evaluation database 17 (step S13). Thus, evaluated specification information d14 including evaluation specification information d13 and determination information d33 is generated and stored in evaluation database 17.

Such evaluated specification information d14 is provided from evaluation database 17 to threat analyzer 21 and vulnerability analyzer 22 as feedback (steps S14 and S15).

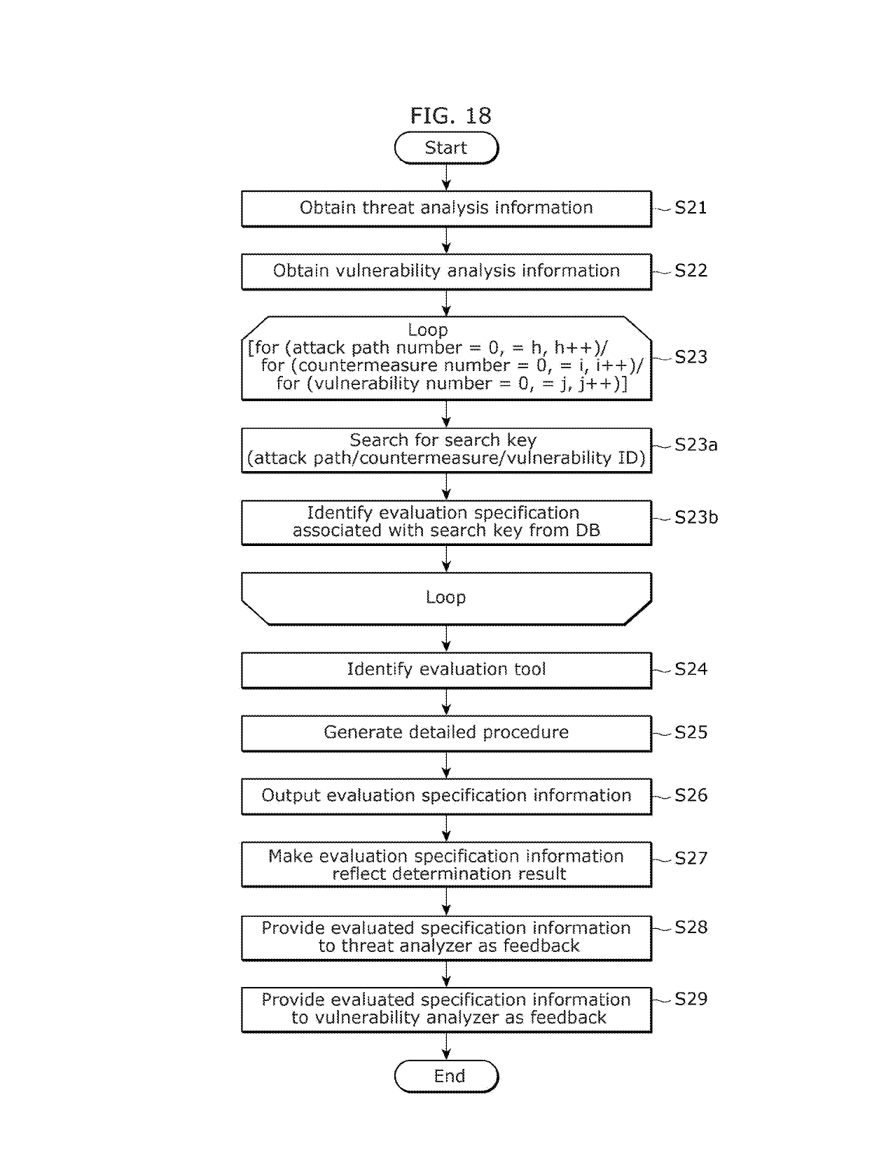

FIG. 18 is a flowchart illustrating an example of a processing operation of evaluation support system 10.

First, obtainer 11 of evaluation support system 10 obtains threat analysis information d21 from threat analyzer 21 (step S21) and further obtains vulnerability analysis information d22 from vulnerability analyzer 22 (step S22).

Next, evaluation specification generator 12 executes a loop using threat analysis information d21 and vulnerability analysis information d22 obtained by obtainer 11 (step S23). This loop includes a first loop, a second loop, and a third loop.

In the first loop, evaluation specification generator 12 searches, for each attack path number, attack path specification information 15a for, as a search key, the set of the attack path ID and attack path corresponding to the attack path number (step S23a). Note that the attack path number is a number assigned to each set of an attack path ID and an attack path indicated in threat analysis information d21. Evaluation specification generator 12 then identifies an evaluation specification associated with the search key in attack path specification information 15a (step S23b). That is, in steps S23a and S23b, evaluation specification generator 12 searches attack path specification information 15a for an evaluation specification associated with the search key.

In the second loop, evaluation specification generator 12 searches, for each countermeasure number, countermeasure specification information 14a for, as a search key, a countermeasure corresponding to the countermeasure number (step S23a). Note that the countermeasure number is a number assigned to each countermeasure indicated in threat analysis information d21. Evaluation specification generator 12 then identifies an evaluation specification associated with the search key in countermeasure specification information 14a (step S23b). That is, in steps S23a and S23b, evaluation specification generator 12 searches countermeasure specification information 14a for an evaluation specification associated with the search key.

In the third loop, evaluation specification generator 12 searches, for each vulnerability number, vulnerability specification information 13a for, as a search key, a vulnerability ID corresponding to the vulnerability number (step S23a). Note that the vulnerability number is a number assigned to each vulnerability ID associated with the determination result "applicable" in vulnerability analysis information d22. Evaluation specification generator 12 then identifies an evaluation specification associated with the search key in vulnerability specification information 13a (step S23b). That is, in steps S23a and S23b, evaluation specification generator 12 searches vulnerability specification information 13a for an evaluation specification associated with the search key.

Note that evaluation specification generator 12 adds a priority to each of the evaluation specifications obtained in the searches as described above.

Evaluation specification generator 12 next refers to evaluation tool information 16a to identify an evaluation tool for each of a plurality of the evaluation specifications that are obtained in the searches in the loops (step S24). Furthermore, evaluation specification generator 12 generates, as a detailed procedure, a procedure for evaluation using the identified evaluation tool and adds the detailed procedure to the evaluation specification (step S25).

Evaluation specification generator 12 then merges the evaluation specifications including their respective detailed procedures and assigns each evaluation specification with a test number to generate evaluation specification information d13 and outputs evaluation specification information d13 (step S26). Evaluation specification information d13 is output to evaluator 32, used in an evaluation of evaluation target device 40, and further stored in evaluation database 17. Then, the result of evaluating evaluation target device 40 is determined by result determiner 33. Thus, determination information d33 indicating the result of the determination is stored in evaluation database 17 by result determiner 33.

By result determiner 33 storing determination information d33 causes evaluation specification information d13 reflecting determination information d33 to be stored in evaluation database 17 as evaluated specification information d14 (step S27). Then, evaluation database 17 (i.e., the feedback provider) provides evaluated specification information d14 to threat analyzer 21, as feedback, (step S28) and further provides evaluated specification information d14 to vulnerability analyzer 22, as feedback (step S29).

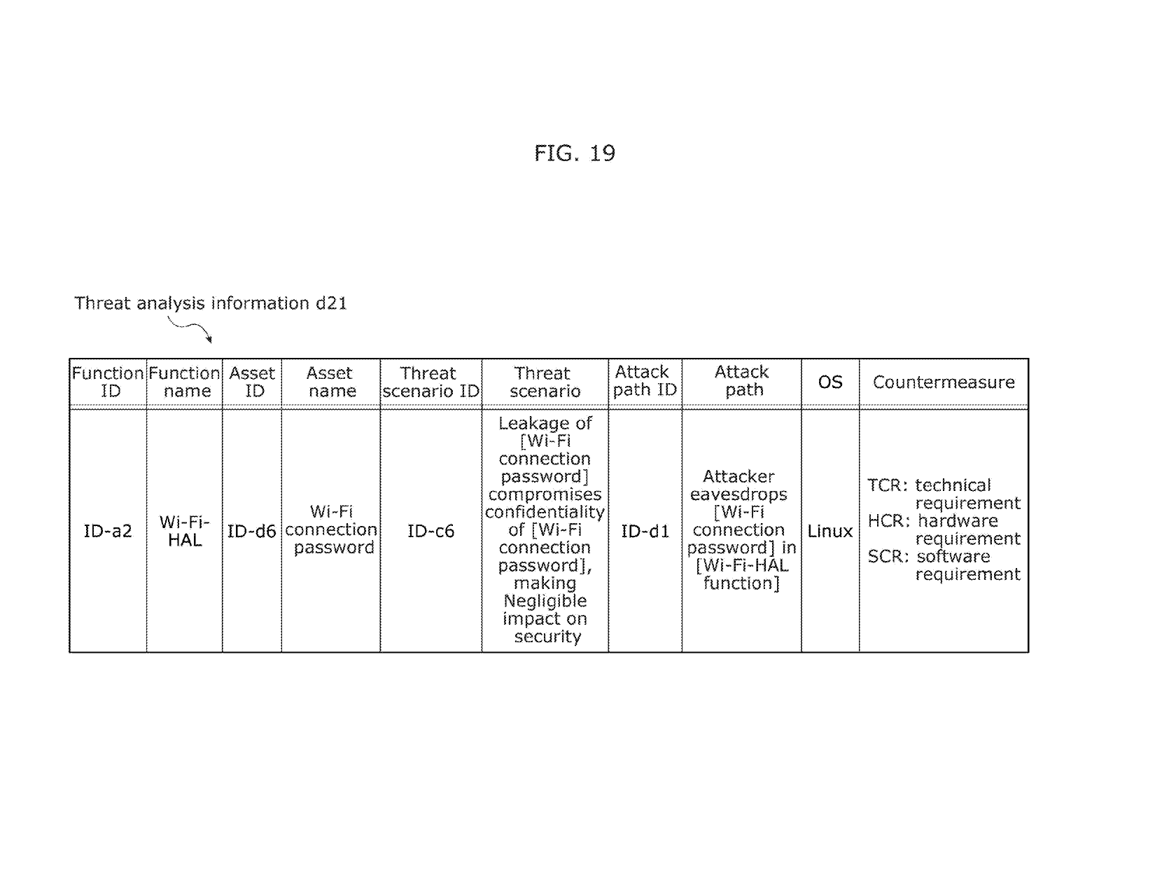

FIG. 19 is a table showing a specific example of threat analysis information d21.

As illustrated in FIG. 19, threat analysis information d21 indicates, for example, the function name "Wi-Fi (Registered Trademark)-HAL" and the asset name "Wi-Fi connection password." Threat analysis information d21 also indicates, as a threat scenario, for example, "The leakage of [Wi-Fi connection password] compromises the confidentiality of [Wi-Fi connection password], making a Negligible impact on security." Threat analysis information d21 further indicates, as an attack path, for example, "An attacker eavesdrops [Wi-Fi connection password] in [Wi-Fi-HAL function]." The "attacker" is the entity described above. The attacker may be added to the detailed procedure. The "attacker" may be added to the detailed procedure after interpreted as an "evaluating person." Threat analysis information d21 also indicates, as an OS, for example, "Linux (Registered Trademark)." Threat analysis information d21 also indicates, as a countermeasure, for example, technical cybersecurity requirement (TCR), hardware cybersecurity requirement (HCR), and software cybersecurity requirement (SCR). TCR is a countermeasure that is required from a technical standpoint. An example of TCR may be "Establish access control and a read/write procedure for vehicle files and data." HCR is a countermeasure that is required from a hardware standpoint. An example of HCR may be "Perform secure boot from a MaskROM, which is tamper-proof." SCR is a countermeasure that is required from a software standpoint. An example of SCR may be "Harden the operating system."

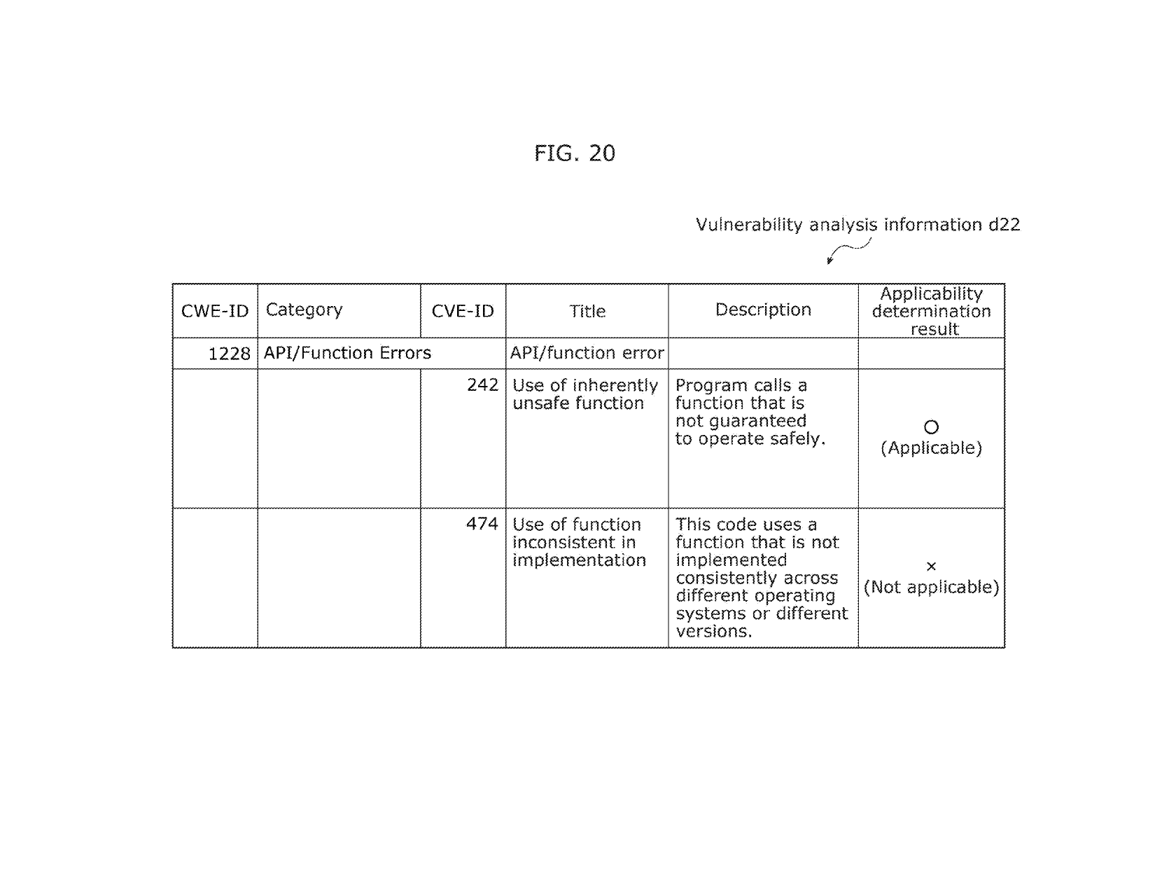

FIG. 20 is a table showing a specific example of vulnerability analysis information d22.

Vulnerability analysis information d22 indicates CWE-ID, Category, Common vulnerabilities and exposures (CVE)-ID, Title, Description, and Applicability determination result. CWE-ID is identification information for identifying the category of a vulnerability. CVE-ID is identification information for identifying a vulnerability that belongs to a category identified with CWE-ID. Title is the title of a vulnerability, and Description is the description of a vulnerability. Vulnerability analysis information d22 indicates, for each CVE-ID, the applicability determination result of a vulnerability identified with the CVE-ID. Accordingly, a vulnerability ID indicated in vulnerability specification information 13a in FIG. 5 may be a CVE-ID rather than a CWE-ID. In a case where a vulnerability ID is a CVE-ID, vulnerability specification information 13a in FIG. 5 can indicate an evaluation specification more finely than a case where the vulnerability ID is a CWE-ID.

FIG. 21 is a table showing a specific example of attack path specification information 15a. FIG. 22 is a table showing a specific example of countermeasure specification information 14a. FIG. 23 is a table showing a specific example of vulnerability specification information 13a.

FIG. 24 is a table showing a specific example of evaluation tool information 16a. Note that Windows, Linux (Registered Trademark), macOS (Registered Trademark), Bluetooth, and Wi-Fi are all registered trademarks.

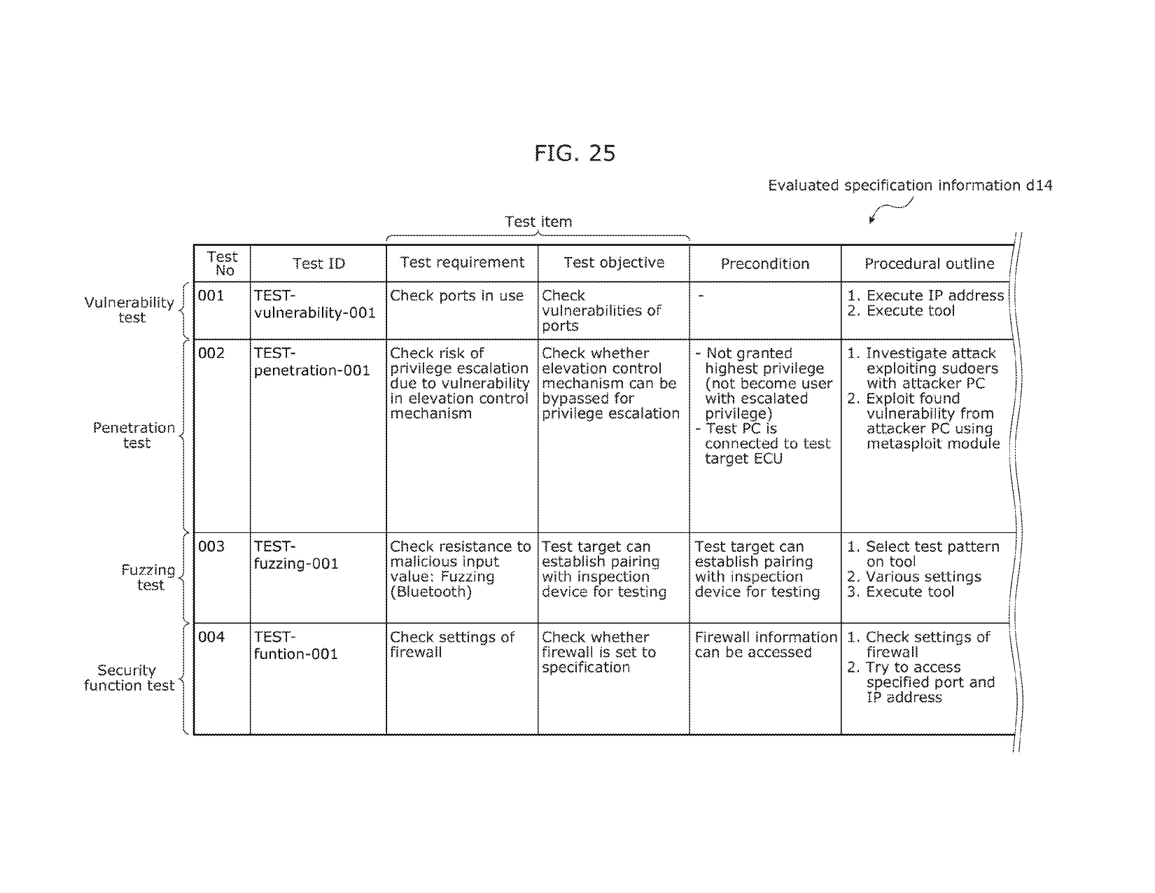

FIG. 25 and FIG. 26 are tables showing a specific example of evaluated specification information d14. FIG. 25 shows a specific example of test numbers, test IDs, test items (i.e., test requirements and test objectives), preconditions, and procedural outlines included in evaluated specification information d14. FIG. 26 shows a specific example of detailed procedures, determination criteria, technical levels, evaluation time periods, influence degrees, priorities, and test results included in evaluated specification information d14.

Evaluated specification information d14 includes a plurality of evaluation specifications each of which is assigned a test number and includes test results that are the evaluation results according to the plurality of evaluation specifications. The plurality of evaluation specifications include, for example, evaluation specifications for a vulnerability test, a penetration test, a fuzzing test, a security function test, and the like. The vulnerability test is an evaluation for detecting a security hole or a bug of software or a system. The penetration test is a test of trying to intrude into a system from the viewpoint of a malicious attacker to find a security weakness. The fuzzing test is a test of sending a large number of invalid inputs or unexpected inputs into software to check whether the software crashes or triggers a bug. The security function test is a test of checking whether the security functions (e.g., authentication, access control, encryption, etc.) of a system properly work. Note that these tests are included in the evaluation of evaluation target device 40.

As described above, evaluation support system 10 in the present embodiment is a system that supports evaluations of evaluation target device 40. Evaluation support system 10 includes obtainer 11 and evaluation specification generator 12. Obtainer 11 obtains threat analysis information d21 indicating analysis results of analyzing threats to information security in evaluation target device 40 and obtains vulnerability analysis information d22 indicating analysis results of analyzing vulnerabilities of the information security in evaluation target device 40. Based on threat analysis information d21 and vulnerability analysis information d22, evaluation specification generator 12 generates evaluation specification information d13 including a plurality of evaluation specifications for evaluation target device 40.

Evaluation specification information d13 including the plurality of evaluation specifications for evaluation target device 40 is thus generated based on threat analysis information d21 and vulnerability analysis information d22. Accordingly, evaluation specification information d13 thus generated covers not only analysis results of analyzing threats to evaluation target device 40 but also analysis results of analyzing vulnerabilities of evaluation target device 40, thus making it possible to improve the coherence of processes from the analysis of threats and vulnerabilities to the generation of evaluation specification information d13. Evaluation specification information d13 also makes it possible to increase the possibility of evaluating evaluation target device 40 comprehensively while preventing necessary evaluations from being missed. That is, evaluation specification information d13 makes it possible to decrease the possibility that security evaluations of evaluation target device 40 become incomplete. Furthermore, the generation of evaluation specification information d13 is automatic, thus making it possible to reduce human-hours to generate evaluation specification information d13. As a result, the evaluations of evaluation target device 40 can be supported more effectively.

Evaluation support system 10 in the present embodiment includes the database that stores security specification information indicating a plurality of security elements and evaluation specifications in association with each other. Evaluation specification generator 12 searches the security specification information for one or more evaluation specifications associated with one or more security elements indicated in threat analysis information d21 as the analysis results of analyzing threats. Evaluation specification generator 12 further searches the security specification information for one or more evaluation specifications associated with one or more security elements indicated in vulnerability analysis information d22 as the analysis results of analyzing vulnerabilities. In the generation of evaluation specification information d13, evaluation specification generator 12 generates evaluation specification information d13 including a plurality of evaluation specifications obtained from the security specification information in searching. Note that the database includes, for example, vulnerability specification database 13, countermeasure specification database 14, and attack path specification database 15. The security specification information includes, for example, vulnerability specification information 13a, countermeasure specification information 14a, and attack path specification information 15a. Each of one or more security elements is a vulnerability, a countermeasure, an attack path, or the like.

Thus, the evaluation specifications based on both the analysis results of analyzing threats and the analysis results of analyzing vulnerabilities are obtained from the security specification information in searching, and evaluation specification information d13 including the evaluation specifications is generated, which enables a plurality of appropriate evaluation specifications to be added to evaluation specification information d13.

The above-described database includes vulnerability specification database 13, which stores vulnerability specification information 13a included in the security specification information. Vulnerability specification information 13a indicates a plurality of vulnerabilities as the plurality of security elements. Vulnerability analysis information d22 indicates, as the one or more security elements, one or more vulnerabilities included in evaluation target device 40. Evaluation specification generator 12 then searches vulnerability specification information 13a for one or more evaluation specifications associated with the one or more vulnerabilities, and in the generation of evaluation specification information d13, evaluation specification generator 12 generates evaluation specification information d13 including one or more evaluation specifications obtained from vulnerability specification information 13a in searching. For example, as illustrated in FIG. 11, evaluation specification generator 12 obtains evaluation specifications from vulnerability specification information 13a in searching.

Thus, the evaluation specifications based on the vulnerabilities included in evaluation target device 40 are obtained from vulnerability specification information 13a in the searching, and evaluation specification information d13 including the evaluation specifications is generated, which enables evaluation specifications appropriate for the vulnerabilities included in evaluation target device 40 to be easily added to evaluation specification information d13.

The above-descried database includes attack path specification database 15, which stores attack path specification information 15a included in the security specification information. Attack path specification information 15a indicates a plurality of attack paths as the plurality of security elements. Threat analysis information d21 indicates, as the one or more security elements, one or more attack paths in evaluation target device 40. Evaluation specification generator 12 then searches attack path specification information 15a for one or more evaluation specifications associated with the one or more attack paths, and in the generation of evaluation specification information d13, evaluation specification generator 12 generates evaluation specification information d13 including one or more evaluation specifications obtained from attack path specification information 15a in searching. For example, as illustrated in FIG. 9, evaluation specification generator 12 obtains evaluation specifications from attack path specification information 15a in searching.

Thus, the evaluation specifications based on the one or more attack paths in evaluation target device 40 are obtained from attack path specification information 15a in the searching, and evaluation specification information d13 including the evaluation specifications is generated, which enables evaluation specifications appropriate for the attack paths in evaluation target device 40 to be easily added to evaluation specification information d13.

The above-descried database includes countermeasure specification database 14, which stores countermeasure specification information 14a included in the security specification information. Countermeasure specification information 14a indicates a plurality of countermeasures as the plurality of security elements. Threat analysis information d21 indicates, as the one or more security elements, one or more countermeasures against one or more threats to evaluation target device 40. Evaluation specification generator 12 then searches countermeasure specification information 14a for one or more evaluation specifications associated with the one or more countermeasures, and in the generation of evaluation specification information d13, evaluation specification generator 12 generates evaluation specification information d13 including one or more evaluation specifications obtained from countermeasure specification information 14a in searching. For example, as illustrated in FIG. 10, evaluation specification generator 12 obtains evaluation specifications from countermeasure specification information 14a in searching.

Thus, the evaluation specifications based on the countermeasures against the one or more threats to evaluation target device 40 are obtained from countermeasure specification information 14a in the searching, and evaluation specification information d13 including the evaluation specifications is generated, which enables evaluation specifications appropriate for the countermeasures against the threats to evaluation target device 40 to be easily added to evaluation specification information d13.

Evaluation support system 10 in the present embodiment includes evaluation tool database 16, which stores evaluation tool information 16a indicating a plurality of conditions and evaluation tools in association with each other. Evaluation specification generator 12 searches evaluation tool information 16a for evaluation tools associated with conditions that are satisfied by analysis results indicated in threat analysis information d21, and in the generation of evaluation specification information d13, evaluation specification generator 12 generates evaluation specification information d13 including evaluation specifications using the evaluation tools obtained from evaluation tool information 16a in searching. For example, as illustrated in FIG. 14, evaluation specification generator 12 obtains evaluation tools from evaluation tool information 16a in searching. Note that, in the example in FIG. 14, each of the plurality of conditions is constituted of the six conditions including the first condition to the sixth condition, and each of the evaluation tools is represented as a tool name. In addition, in the example in FIG. 14, the analysis results indicated in threat analysis information d21 described above each include a function with a function ID and a function name, and an OS.

Thus, evaluation specification information d13 including the evaluation specifications using the evaluation tools based on the analysis results of analyzing the threats is generated, which enables evaluation specifications according to which evaluations can be appropriately executed to be easily added to evaluation specification information d13.

In the generation of evaluation specification information d13, evaluation specification generator 12 in the present embodiment generates, by using a function and an attack path each indicated in threat analysis information d21 as an analysis result, a procedure for evaluation of evaluation target device 40. Evaluation specification generator 12 adds the generated procedure for evaluation to at least one of the plurality of evaluation specifications. For example, as illustrated in FIG. 14, the procedure for evaluation is generated as a detailed procedure and added to the at least one of the plurality of evaluation specifications.

A procedure for evaluation is thus added to an evaluation specification as, for example, a detailed procedure, making it possible to increase the possibility that an evaluating person can perform appropriate evaluations without hesitation by referring to the detailed procedure. In addition, for example, by generating a detailed procedure for each commodity, which is evaluation target device 40, an evaluation can be performed appropriately on each commodity.

Each of the plurality of evaluation specifications in the present embodiment includes a criterion for an evaluation result of evaluation target device 40. In the example illustrated in FIG. 15 or the like, the criterion is equivalent to a determination criterion.

Each of the evaluation specifications includes a criterion as, for example, a determination criterion. Thus, in a case where the evaluation is performed according to the evaluation specifications, it is easy to determine whether an evaluation result is OK or NG using the determination criterion.

Evaluation specification generator 12 in the present embodiment also determines the priority of each of the plurality of evaluation specifications obtained from the security specification information in searching.

Thus, referring to the priorities of the plurality of evaluation specifications, the evaluating person can easily determine an evaluation specification based on which to execute an evaluation first and an evaluation specification based on which to execute an evaluation later. Accordingly, an important evaluation can be executed first to prevent the important evaluation from being executed later.

The security specification information in the present embodiment indicates, for each of the evaluation specifications, a technical level, an evaluation time period, and an influence degree of the evaluation specification by numerical values. In the determination of a priority, evaluation specification generator 12 identifies, for each of the plurality of evaluation specifications obtained from the security specification information in searching, a technical level, an evaluation time period, and an influence degree each corresponding to the evaluation specification from the security specification information. Evaluation specification generator 12 then determines the priority by performing weighted addition of the identified technical level, evaluation time period, and influence degree.

Thus, the priority of an evaluation specification is determined by performing the weighted addition on the technical level, evaluation time period, and influence degree of the evaluation specification. Accordingly, for example, increasing the weight for technical level enables the priority to be determined mainly from the viewpoint of technical level, and increasing the weight for evaluation time period enables the priority to be determined mainly from the viewpoint of evaluation time period. Alternatively, increasing the weight for influence degree enables the priority to be determined mainly from the viewpoint of influence degree (e.g., quality). In addition, for example, by adjusting the weights for each commodity, which is the evaluation target device, the priority can be determined appropriately for the commodity.

Evaluation support system 10 in the present embodiment includes the feedback provider that provides, as feedback, evaluation specification information d13 indicating the evaluation results of evaluation target device 40 that are obtained by evaluations according to evaluation specification information d13, as evaluated specification information d14 to threat analyzer 21 and vulnerability analyzer 22. Threat analyzer 21 generates threat analysis information d21 by analyzing a threat to evaluation target device 40. Vulnerability analyzer 22 generates vulnerability analysis information d22 by analyzing vulnerabilities of evaluation target device 40. Note that, in the examples in FIG. 16 and FIG. 26, evaluated specification information d14 indicates test results as the evaluation results of evaluation target device 40. In addition, in the example illustrated in FIG. 1, the feedback provider is configured in the form of evaluation database 17.

Evaluated specification information d14 is thus provided to threat analyzer 21 and vulnerability analyzer 22 as feedback. Accordingly, threat analyzer 21 can guarantee the analysis result of analyzing a threat with regard to an evaluation specification about which a favorable evaluation result is indicated in evaluated specification information d14. For example, in a case where the analysis result is about a countermeasure to the threat, threat analyzer 21 can guarantee the effectiveness of the countermeasure. With regard to an evaluation specification about which an unfavorable evaluation result is indicated in evaluated specification information d14, threat analyzer 21 can improve its threat analysis. For example, in a case where the analysis result is about a countermeasure to the threat, threat analyzer 21 can improve the countermeasure. As a result, the accuracy of formulating the countermeasure can be increased. Vulnerability analyzer 22 can increase the accuracy of its vulnerability analysis based on the evaluation results indicated in evaluated specification information d14. That is, in the present embodiment, the evaluation support system not only provides a one-way traffic from the threat analysis and vulnerability analysis to the evaluation but also provides the evaluation result to the threat analysis and vulnerability analysis as feedback, thus enabling the risk management of evaluation target device 40 to be performed effectively.

Although evaluation support system 10 and the evaluation support method according to one or more aspects of the present disclosure have been described based on an embodiment, the present disclosure is not limited to the embodiment. Those skilled in the art will readily appreciate that embodiments arrived at by making various modifications to the above embodiment without materially departing from the scope of the present disclosure may be included within one or more aspects of the present disclosure.

For example, in the above-described embodiment, evaluation support system 10 is not provided with an input unit that receives an input operation by a user. However, evaluation support system 10 may be provided with the input unit. The user performing an input operation on the input unit can thus easily input the evaluation environment elements such as a license type, a protocol, an execution form, and an output format. The user may also input any type of information relating to the generation of evaluation specification information d13.

In the above-described embodiment, a function ID and a function name are both indicated in threat analysis information d21. However, only one of them may be indicated in threat analysis information d21. Likewise, in the above-described embodiment, an asset ID and an asset name are both indicated in threat analysis information d21. However, only one of them may be indicated in threat analysis information d21. Likewise, in the above-described embodiment, an attack path ID and an attack path are both indicated in threat analysis information d21. However, only one of them may be indicated in threat analysis information d21. In this case, attack path specification information 15a may indicate only one of the attack path ID or the attack path.

In the above-described embodiment, evaluation target device 40 is an ECU. However, evaluation target device 40 may be any other device that performs information processing.

In the above-described embodiment, evaluated specification information d14 is stored in evaluation database 17, and evaluated specification information d14 is provided as feedback. Here, for an evaluation item resulting in a determination result (specifically, NG) included in evaluated specification information d14, a new countermeasure plan for the evaluation item may be stored in evaluation database 17 and provided as feedback. The new countermeasure plan may be stored by a manual input operation.

Evaluated specification information d14 and the like may be provided, as feedback, to not only threat analyzer 21 and vulnerability analyzer 22 but also another constituent component. The other constituent component may be a security executor or may be a cyber security (CS)-regulatory compliance unit or the like. The security executor executes a process performed as the bottom of a V-model of an automobile development process. The security executor executes coding of software programs of evaluation target device 40.

In the above-described embodiment, evaluation support system 10 is not provided with evaluator 32 and result determiner 33. However, evaluation support system 10 may be provided with these constituent components.

In the above-described embodiment, the constituent components included in evaluation support system 10 may perform their respective processes in response to a manual input operation or may perform the processes automatically without receiving the input operation. The constituent components included in development system 100 may perform their respective processes in response to a manual input operation or may perform the processes automatically without receiving the input operation, as in the above description. For a process performed automatically, for example, a machine learning model representing the correlation between input and output may be used.

Note that, in the above-described embodiment, the constituent components may be configured with dedicated hardware or may be implemented by executing a software program suitable for the constituent components. Each constituent component may be implemented by a program executor such as a central processing unit (CPU) or a processor reading and executing a software program recorded in a recording medium such as a hard disk or a semiconductor memory. Here, pieces of software that implement the evaluation support system and the like in the above-described embodiment are computer programs that cause a computer to execute the steps in the flowchart illustrated in FIG. 18.

Note that the present disclosure also includes the cases described below.

(1) At least one of the foregoing system or device is, more specifically, a computer system that includes a microprocessor, a Read Only Memory (ROM), a Random Access Memory (RAM), a hard disk unit, a display unit, a keyboard, a mouse, etc. The RAM or the hard disk unit stores the computer program. The microprocessor’s operating in accordance with the computer program enables at least one of the foregoing system or device to achieve its function. Here, the computer program is configured, using a combination of a plurality of command codes representing instructions given to the computer to achieve a predetermined function.

(2) One or more, or all of the elements included in at least one of the foregoing system or device may be configured in the form of a single system Large Scale Integration (LSI). The system LSI is a super-multifunctional LSI that is manufactured by integrating a plurality of elements onto a single chip. The system LSI is, more specifically, a computer system that is configured by including a microprocessor, a ROM, a RAM, etc. The RAM stores the computer program. The microprocessor’s operating in accordance with the computer program enables the system LSI to achieve its function.

(3) One or more, or all of the elements included in at least one of the foregoing system or device may be implemented in the form of an Integrated Circuit (IC) card or a single module each of which is removable from the device. The IC card or the module is a computer system that includes a microprocessor, a ROM, a RAM, etc. The IC card or the module may include the foregoing super-multifunctional LSI. The microprocessor’s operating in accordance with the computer program enables the IC card or the module to achieve its function. Such IC card or the module may be tamper resistant.

(4) The present disclosure may be the method described above. The present disclosure may also be a computer program that enables such method to be implemented by means of a computer, or digital signals that form a computer program.

The present disclosure may be configured by means of recording a computer program or digital signals on a computer-readable recording medium such as a flexible disk, a hard disk, a Compact Disc (CD)-ROM, a Digital Versatile Disc (DVD), a DVD-ROM, a DVD-RAM, a Blu-ray(registered trademark) disc (BD), and a semiconductor memory. The present disclosure may also be digital signals recorded in such recording medium.

The present disclosure may be configured by means of transmitting the computer program or the digital signals via, for example, a telecommunication line, a wireless or wired communication line, a network represented by the Internet, and data broadcasting.

The present disclosure may be implemented by means of transmitting the program or the digital signals recorded on a recording medium or transmitting the program or the digital signals via, for example, a network, thereby enabling another independent computer system to carry out the present disclosure.

### Further I n formation about Technical Background to this Application

The disclosure of the following patent application including specification, drawings, and claims is incorporated herein by reference in their entirety: Japanese Patent Application No. 2025-006249 filed on January 16, 2025.

### Industrial Applicability

The evaluation support system according to the present disclosure is applicable to, for example, a device or system that supports evaluations of an ECU to be built in a vehicle or the like.

1. An evaluation support system that supports evaluation of an evaluation target device, the evaluation support system comprising:
a processor; and
a memory coupled to the processor, wherein
using the memory, the processor executes:
obtaining processing of obtaining threat analysis information and vulnerability analysis information, the threat analysis information indicating an analysis result of analyzing a threat to information security in the evaluation target device, the vulnerability analysis information indicating an analysis result of analyzing a vulnerability of the information security in the evaluation target device; and
evaluation specification generating processing of generating evaluation specification information including a plurality of evaluation specifications for the evaluation target device, based on the threat analysis information and the vulnerability analysis information.

2. The evaluation support system according to claim 1, further comprising:
a database that stores security specification information indicating a plurality of security elements and evaluation specifications in association with each other, wherein
in the evaluation specification generating processing, the processor:
searches the security specification information to obtain one or more first evaluation specifications associated with one or more security elements indicated in the threat analysis information as the analysis result of analyzing a threat; and
searches the security specification information to obtain one or more second evaluation specifications associated with one or more security elements indicated in the vulnerability analysis information as the analysis result of analyzing a vulnerability, and
in the evaluation specification generating processing, the processor generates the evaluation specification information including a plurality of evaluation specifications that are the one or more first evaluation specifications and the one or more second evaluation specifications each obtained from the security specification information in the searching.

3. The evaluation support system according to claim 2, wherein
the database includes a vulnerability specification database that stores vulnerability specification information included in the security specification information,
the vulnerability specification information indicates a plurality of vulnerabilities as the plurality of security elements,
the vulnerability analysis information indicates, as the one or more security elements, one or more vulnerabilities included in the evaluation target device,
the processor searches the vulnerability specification information for one or more evaluation specifications associated with the one or more vulnerabilities, and
in the evaluation specification generating processing, the processor generates the evaluation specification information including the one or more evaluation specifications obtained from the vulnerability specification information in the searching.

4. The evaluation support system according to claim 2, wherein
the database includes an attack path specification database that stores attack path specification information included in the security specification information,
the attack path specification information indicates a plurality of attack paths as the plurality of security elements,
the threat analysis information indicates, as the one or more security elements, one or more attack paths in the evaluation target device,
the processor searches the attack path specification information for one or more evaluation specifications associated with the one or more attack paths, and
in the evaluation specification generating processing, the processor generates the evaluation specification information including the one or more evaluation specifications obtained from the attack path specification information in the searching.

5. The evaluation support system according to claim 2, wherein
the database includes a countermeasure specification database that stores countermeasure specification information included in the security specification information,
the countermeasure specification information indicates a plurality of countermeasures as the plurality of security elements,
the threat analysis information indicates, as the one or more security elements, one or more countermeasures against one or more threats to the evaluation target device,
the processor searches the countermeasure specification information for one or more evaluation specifications associated with the one or more countermeasures, and
in the evaluation specification generating processing, the processor generates the evaluation specification information including the one or more evaluation specifications obtained from the countermeasure specification information in the searching.

6. The evaluation support system according to claim 1, further comprising:
an evaluation tool database that stores evaluation tool information indicating a plurality of conditions and evaluation tools in association with each other, wherein
the processor searches the evaluation tool information for an evaluation tool associated with a condition which the analysis result indicated in the threat analysis information satisfies, and
in the evaluation specification generating processing, the processor generates the evaluation specification information including an evaluation specification using the evaluation tool obtained from the evaluation tool information in the searching, the evaluation specification being included in the plurality of evaluation specifications.

7. The evaluation support system according to claim 1, wherein
in the evaluation specification generating processing, the processor:
generates, by using a function and an attack path each indicated in the threat analysis information as the analysis result, a procedure for evaluation of the evaluation target device; and
adds the procedure generated to at least one of the plurality of evaluation specifications.

8. The evaluation support system according to claim 1, wherein
each of the plurality of evaluation specifications includes a criterion for an evaluation result of the evaluation target device.

9. The evaluation support system according to claim 2, wherein
the processor further determines a priority of each of the plurality of evaluation specifications obtained from the security specification information in the searching.

10. The evaluation support system according to claim 9, wherein
the security specification information indicates, for each of the evaluation specifications, a technical level, an evaluation time period, and an influence degree by numerical values, and
in the determination of the priority, for each of the plurality of evaluation specifications obtained from the security specification information in the searching, the processor:
identifies, from the security specification information, a technical level, an evaluation time period, and an influence degree each corresponding to the evaluation specification; and
determines the priority by performing weighted addition of the technical level identified, the evaluation time period identified, and the influence degree identified.

11. The evaluation support system according to claim 1, wherein
the processor provides, to a threat analysis circuit and a vulnerability analysis circuit, evaluated specification information, as feedback, the evaluated specification information being the evaluation specification information indicating an evaluation result of the evaluation target device, the evaluation result being obtained by evaluation based on the evaluation specification information,
the threat analysis circuit generates the threat analysis information by analyzing a threat to the evaluation target device, and
the vulnerability analysis circuit generates the vulnerability analysis information by analyzing a vulnerability of the evaluation target device.

12. An evaluation support method of supporting evaluation of an evaluation target device, the evaluation support method comprising:
obtaining threat analysis information and vulnerability analysis information, the threat analysis information indicating an analysis result of analyzing a threat to information security in the evaluation target device, the vulnerability analysis information indicating an analysis result of analyzing a vulnerability of the information security in the evaluation target device; and
generating evaluation specification information including a plurality of evaluation specifications for the evaluation target device, based on the threat analysis information and the vulnerability analysis information.
